(19) United States
(12) Patent Application Publication
(10) Pub. No.: US 2025/0275002 A1
(43) Pub. Date: Aug. 28, 2025

(54) COMMUNICATION APPARATUS AND COMMUNICATION METHOD FOR MULTI-LINK WLAN MEASUREMENTS

(71) Applicant: Panasonic Intellectual Property Corporation of America, Torrance, CA (US)

(72) Inventors: Rojan CHITRAKAR, Singapore (SG); Yoshio URABE, Nara (JP)

(21) Appl. No.: 18/858,212

(22) PCT Filed: Dec. 8, 2022
(86) PCT No.: PCT/SG2022/050891

§ 371 Date: Oct. 18, 2024

(30) Foreign Application Priority Data
Apr. 22, 2022 (SG) 10202204271T

(51) Int. Cl. H04W 76/15; H04W 24/10; H04W 84/12

(52) U.S. Cl. CPC H04W 76/15; H04W 24/10; H04W 84/12

(57) ABSTRACT

Communication apparatuses and methods for multi-link WLAN sensing and/or ranging are provided. The techniques disclosed here feature a first multi-link device (MLD) comprising a first plurality of affiliated stations (STAs), wherein the first MLD comprises: at least one transceiver, and circuitry, wherein the at least one transceiver works in conjunction with the circuitry, which in operation enables one or more STAs of the first plurality of affiliated STAs to perform measurement operations with one or more STAs of a second plurality of affiliated STAs comprised in a second MLD.

### BACKGROUND

### 1. Technical Field

The present disclosure relates generally to wireless local-area network (WLAN) operations, and more particularly relates to communication apparatuses and communication methods for multi-link WLAN measurement procedures such as sensing and/or ranging.

### 2. Description of the Related Art

WLAN sensing is under development by IEEE 802.11bf Task Group. WLAN sensing is the use, by one or more WLAN sensing capable stations (STAs), of received WLAN signals to detect feature(s) of a given environment. For example, the features include one or more of range, velocity, angular, motion, presence or proximity, gesture, etc. of an intended target. The intended target can be any object, human, animal, etc. The given environment can be a room, a house, a vehicle, an enterprise, etc., Multi-Link WLAN sensing is an extension of WLAN sensing by simultaneously performing sensing over multiple links.

According to 802.11bf, Wireless Local Area Network (WLAN) sensing operations will be performed in license-exempt frequency bands between 1 GHz and 7.125 GHz and above 45 GHz.

Meanwhile, IEEE 802.11be Extremely High Throughput (EHT) amendment has introduced a concept of multi-link device (MLD) allowing communications between two MLDs over multiple wireless links.

MLDs thus seem to be useful to achieve multi-link WLAN sensing. However, there has been no related discussion in 802.11bf yet. In 802.11be, all EHT access points (APs) are affiliated with an AP MLD and there are no standalone EHT APs. On the other hand, in 802.11bf, all sensing related procedures assume signalling between two standalone peer STAs (e.g., between a non-Access Point (AP) STA and an AP). If either one or both of the peer STAs is affiliated with a multi-link device (MLD), it is not clear whether the sensing related procedures will work as defined in 802.11bf.

There is currently no detailed solution and procedure on how to make the 802.11bf WLAN sensing procedures work with STAs affiliated with MLDs. Thus, there is a need for communication apparatuses and methods to address the above mentioned issues by providing solutions and procedures of multi-link WLAN sensing as described in the present disclosure. Furthermore, other desirable features and characteristics will become apparent from the subsequent detailed description and the appended claims, taken in conjunction with the accompanying drawings and this background.

### SUMMARY

One non-limiting and exemplary embodiment facilitates multi-link WLAN sensing procedures. In addition, the technical solutions provided in the present disclosure are not only applicable to a WLAN sensing procedure over multiple links using MLDs (i.e., multi-link WLAN sensing procedures), but also applicable to other WLAN applications such as Ranging for WLAN positioning (regulated by 802.11az and also known as fine time measurements) over multiple links (i.e. multi-link WLAN ranging procedures).

In an embodiment, the techniques disclosed herein feature a first multi-link device (MLD) comprising a first plurality of affiliated stations (STAs), wherein the first MLD comprises: at least one transceiver, and circuitry, wherein the at least one transceiver works in conjunction with the circuitry, which in operation enables one or more STAs of the first plurality of affiliated STAs to perform measurement operations with one or more STAs of a second plurality of affiliated STAs comprised in a second MLD.

It should be noted that general or specific embodiments may be implemented as a system, a device, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE FIGURES

In the following, exemplary embodiments are described in more detail with reference to the attached figures and drawings.

FIG. 1 shows an exemplary WLAN sensing procedure 100 as defined in IEEE802.11bf. As described above, in 802.11bf, all sensing related procedures in the exemplary WLAN sensing procedure 100 assume signalling between two standalone peer STAs (e.g., a sensing initiator 102 and a sensing responder 104 as depicted in FIG. 1).

FIG. 2 is a schematic illustration 200 which shows multi-link communications between two MLDs over multiple wireless links as defined in IEEE802.11be.

FIG. 3 depicts a block diagram 300 of an exemplary communication apparatus 310 that can be implemented as a first MLD or a second MLD for multi-link WLAN sensing or ranging procedures in accordance with embodiments of the present disclosure based on practical requirements.

FIG. 4 illustrates a flowchart illustrating a method 400 implemented by a first MLD for multi-link WLAN sensing or ranging procedures in accordance with an embodiment of the present disclosure.

FIG. 5 illustrates a schematic illustration of an embodiment 500 in which the method 400 is implemented as a multi-link WLAN sensing procedure 500 between a first MLD 502 and a second MLD 504 implemented by the communication apparatus 310.

FIG. 6 illustrates a flowchart illustrating an embodiment 600 of the multi-link WLAN sensing procedure 500 between a first MLD 602 and a second MLD 604.

FIG. 7 illustrates a flowchart illustrating another embodiment 700 of the multi-link WLAN sensing procedure 500 between a first MLD 702 and a second MLD 704.

FIG. 8 depicts a block diagram of an embodiment 800 of the exemplary communication apparatus 310 implemented as a first MLD 800 in accordance with embodiments of the present disclosure. In particular, the embodiment 800 enables a centralized and efficient management and utilization of multiple links at the MLD level for multi-link WLAN measurement procedures in accordance with embodiments depicted in FIGS. 9 to 34. It is understandable to those skilled in the art that the embodiment 800 can also be implemented as a second MLD in accordance with embodiments of the present disclosure based on practical requirements.

FIG. 9 illustrates a flowchart illustrating another embodiment 900 in which the method 400 is implemented as a multi-link WLAN sensing procedure 900 between a first MLD 902 and a second MLD 904 implemented by embodiment 800 of the exemplary communication apparatus 310. When a WLAN Sensing procedure is performed between an MLD and a non-MLD STA or AP, the affiliated STA of the MLD that operated on the same link as the non-MLD STA will act as the sensing initiator or sensing responder, that means the roles will be same as that between two non-MLD STAs.

FIG. 10 illustrates a block diagram depicting an exemplary signaling process 1000 between a first MLD 1002 and a second MLD 1004 during a multi-link WLAN sensing procedure. In this exemplary signaling process 1000, the first MLD 1002 and the second MLD 1004 have been associated prior to a multi-link sensing session setup stage 1010. An alternative exemplary signaling process 3100 is depicted in FIG. 31, in which the first MLD 1002 and the second MLD 1004 are not associated prior to the multi-link sensing session setup 1010. Details of the alternative exemplary signaling process 3100 are illustrated in FIG. 31 and described in the corresponding paragraphs.

FIG. 11 illustrates a flowchart illustrating another embodiment 1100 of the method 400. In this embodiment, the method 400 is implemented as a multi-link WLAN sensing procedure 1100 between a first MLD 1102, a second MLD 1104 and another second MLD 1106.

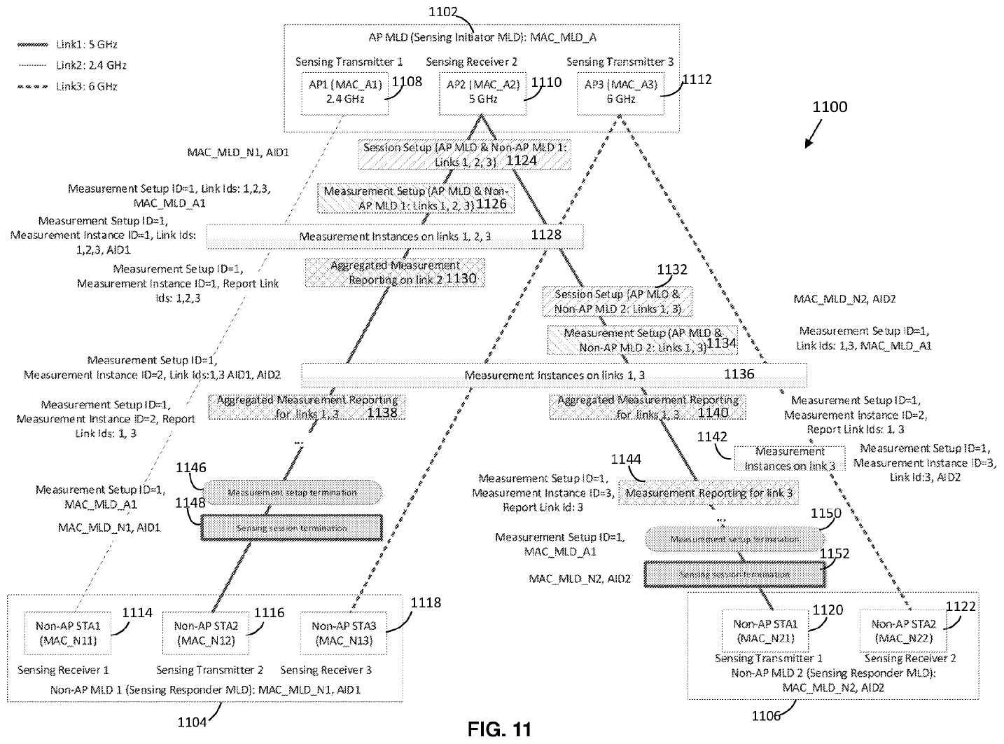

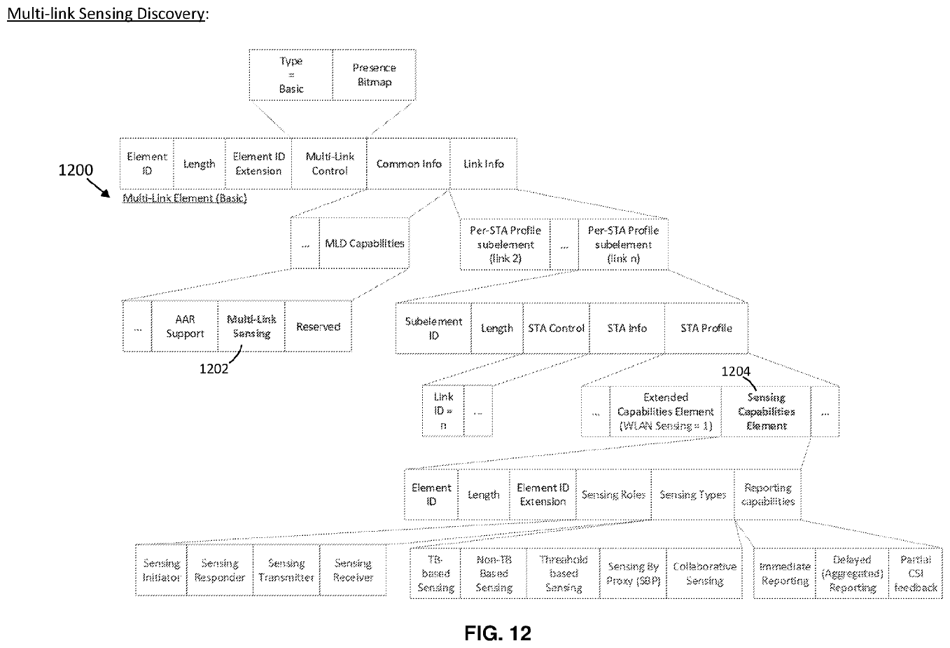

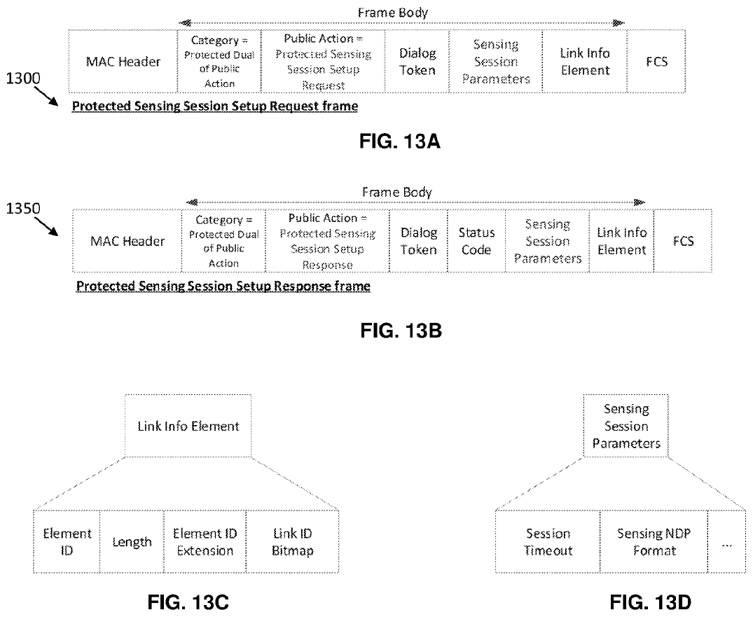

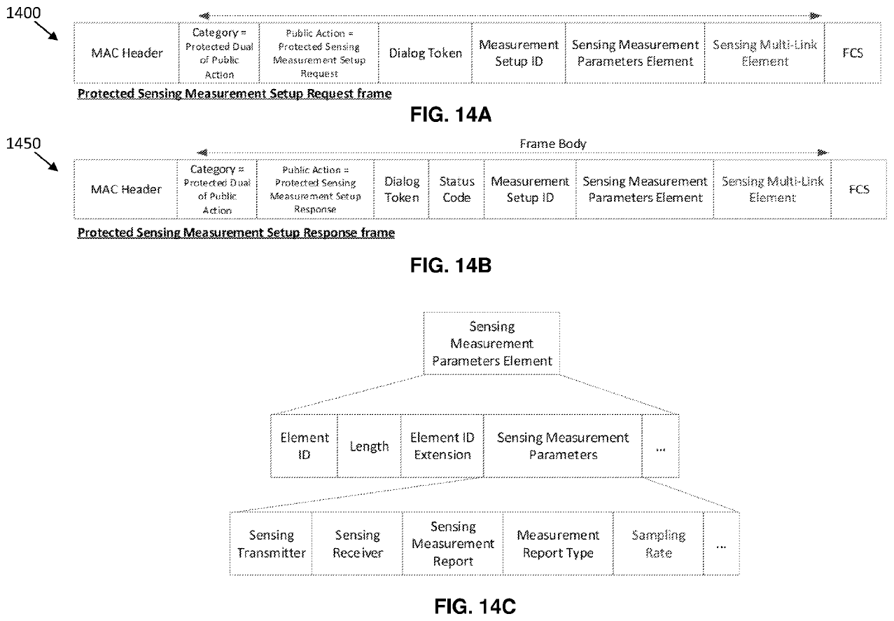

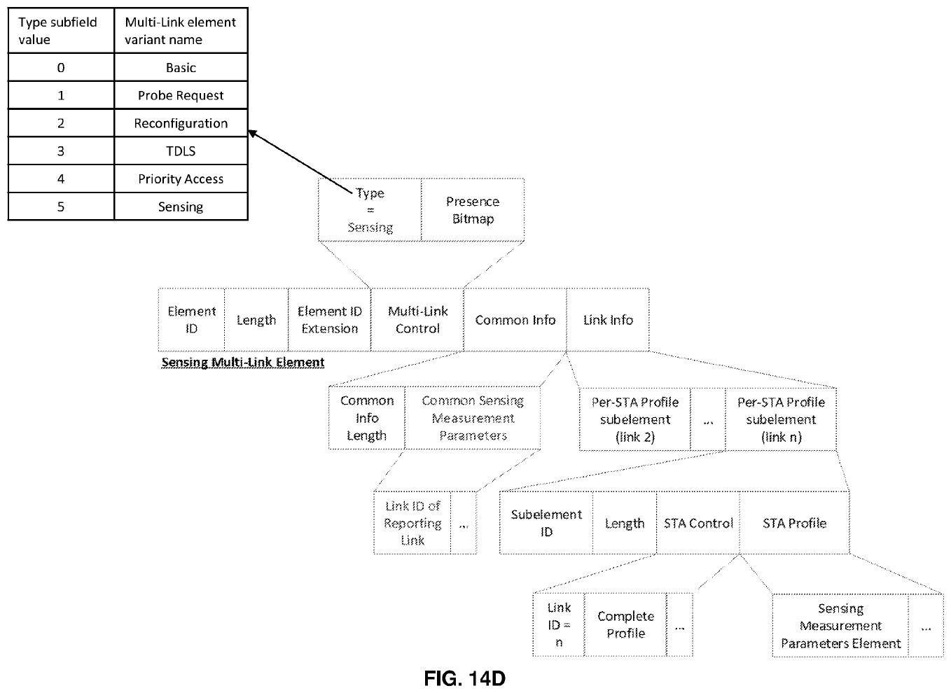

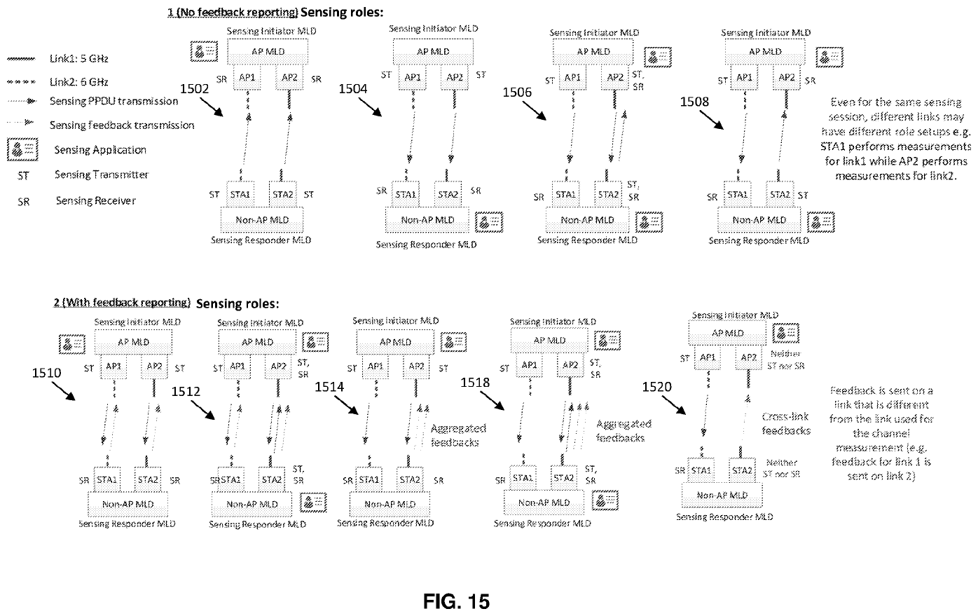

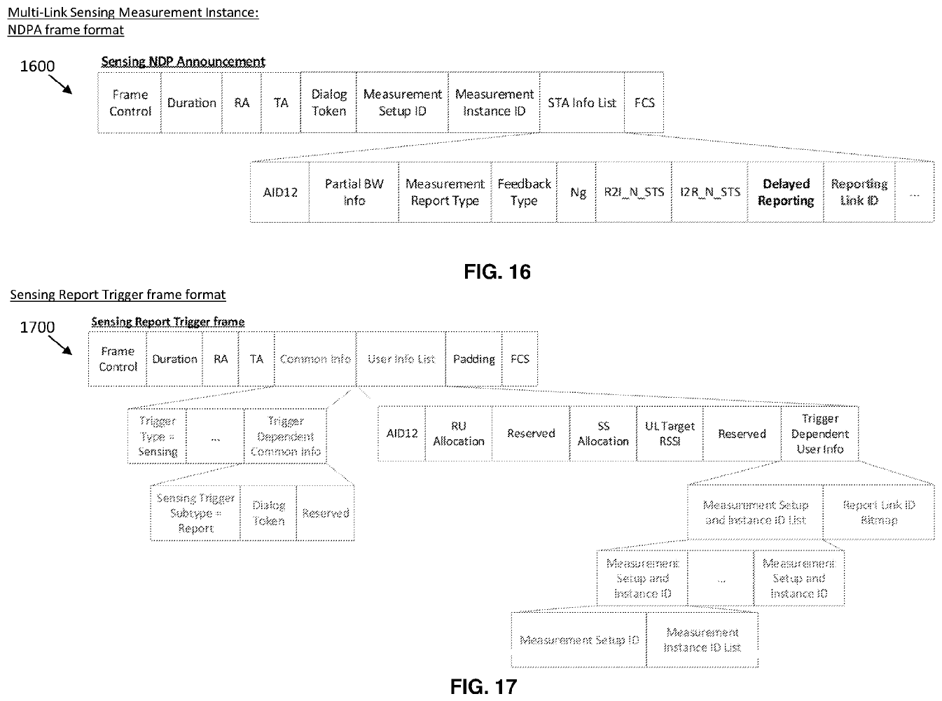

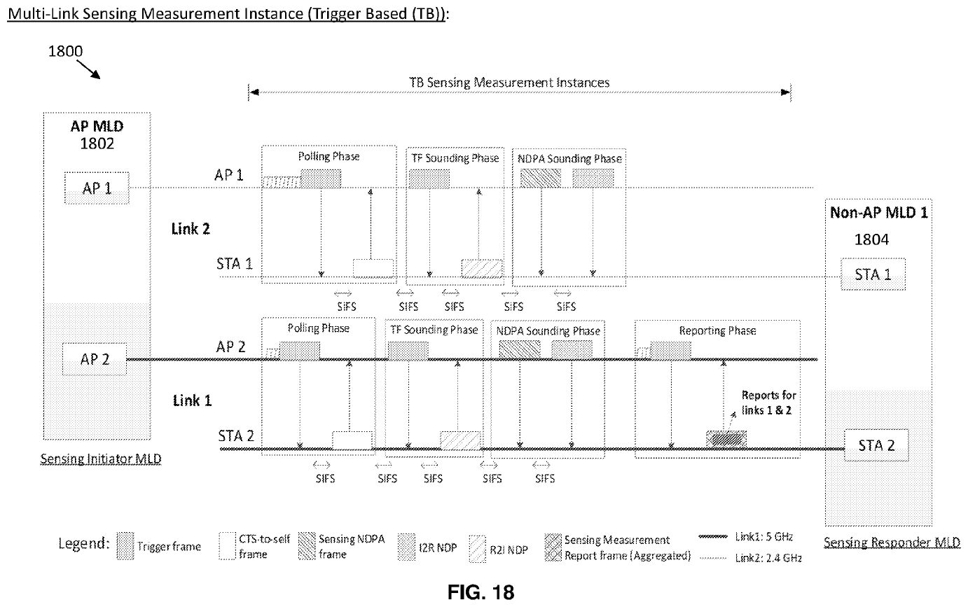

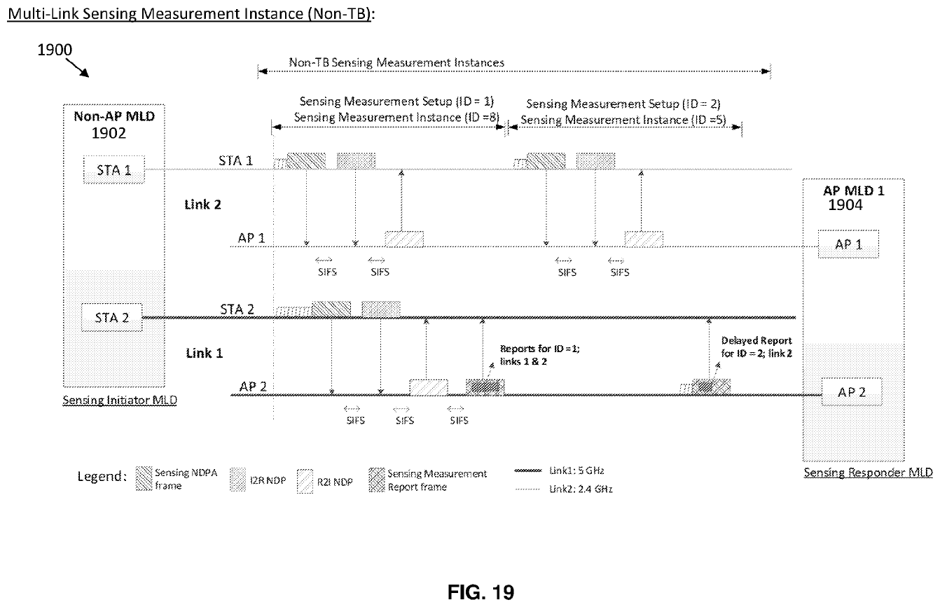

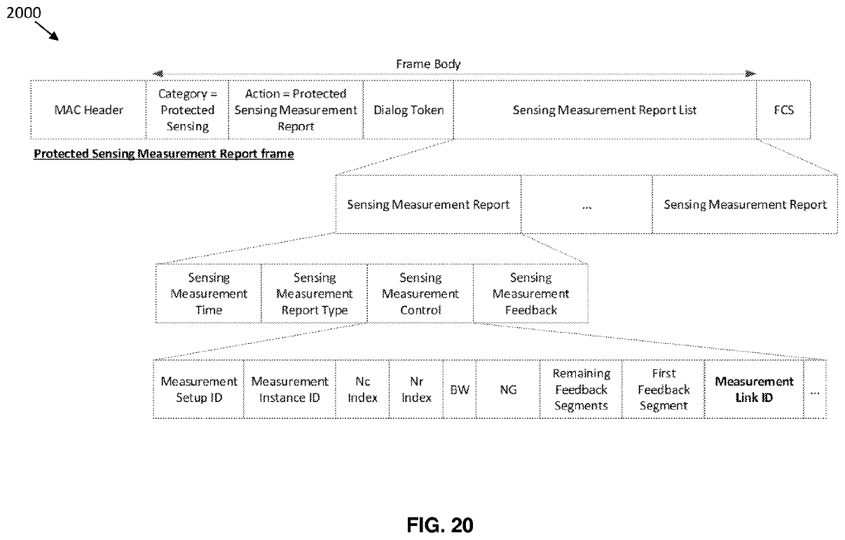

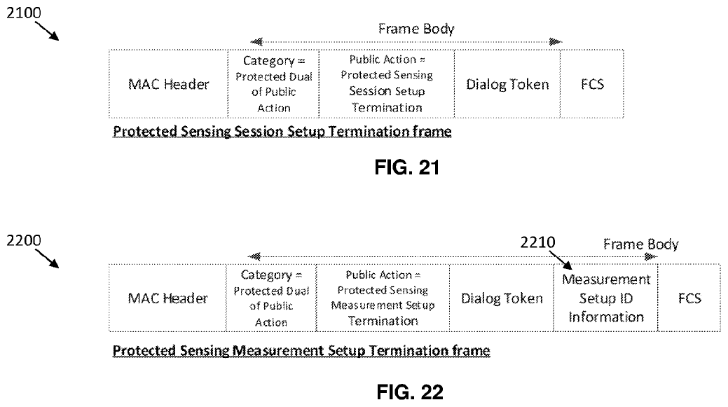

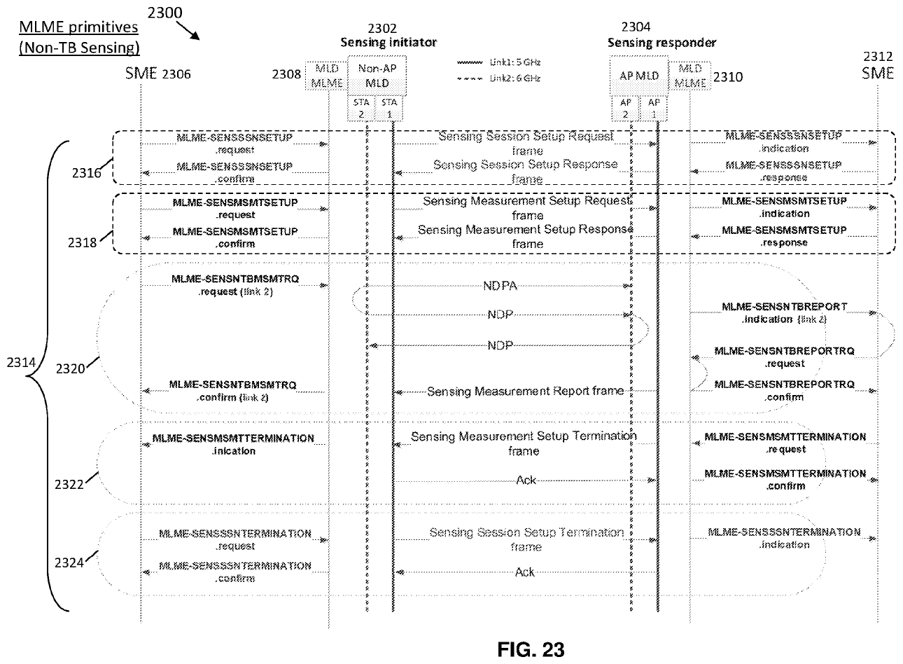

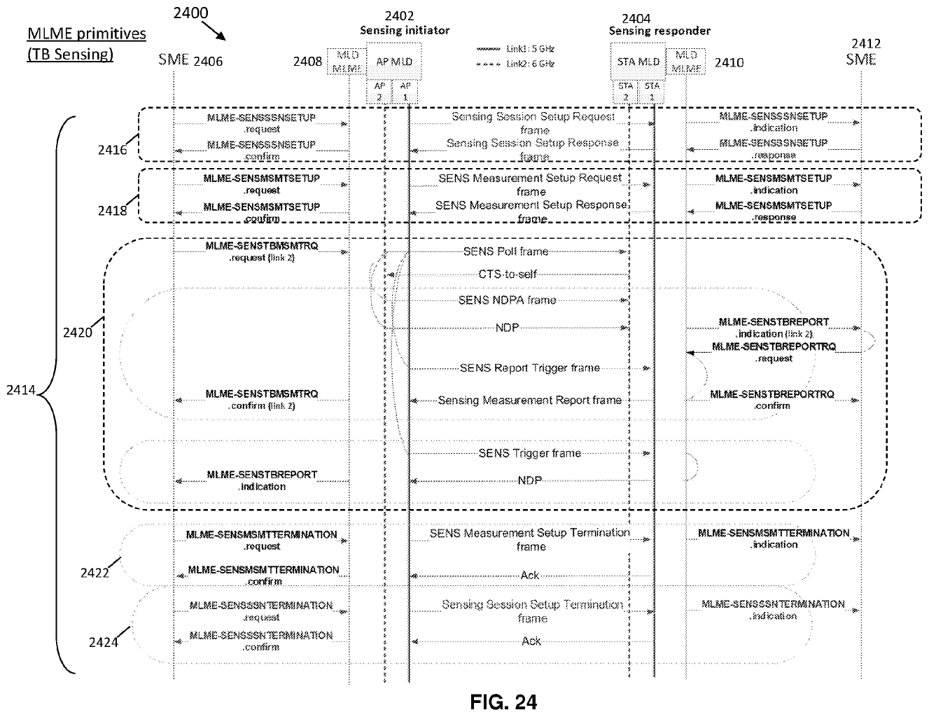

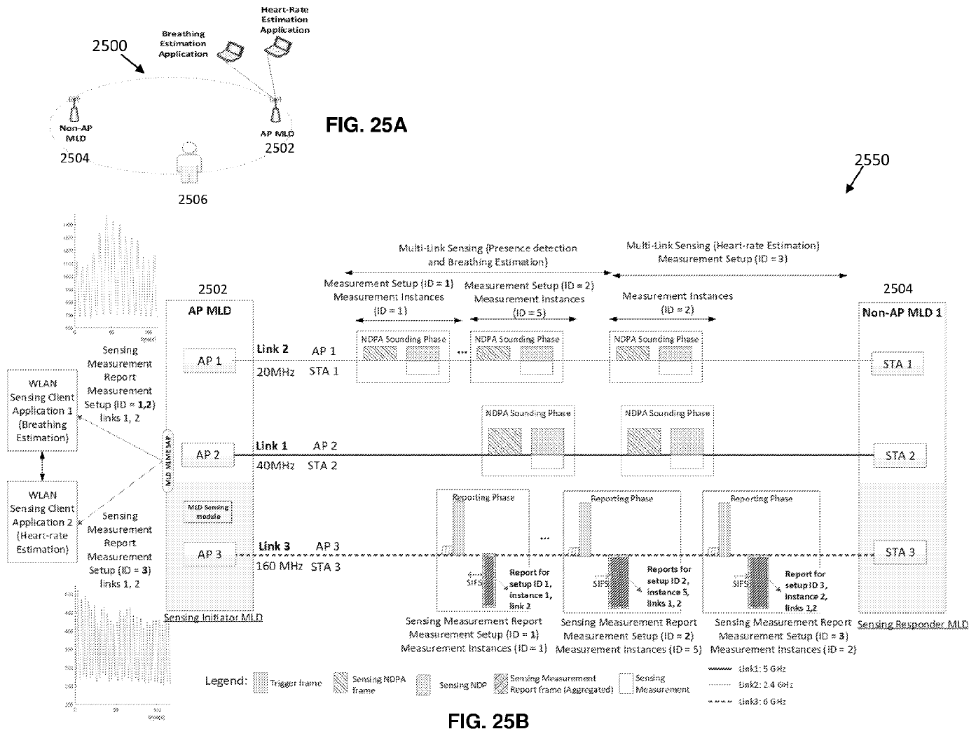

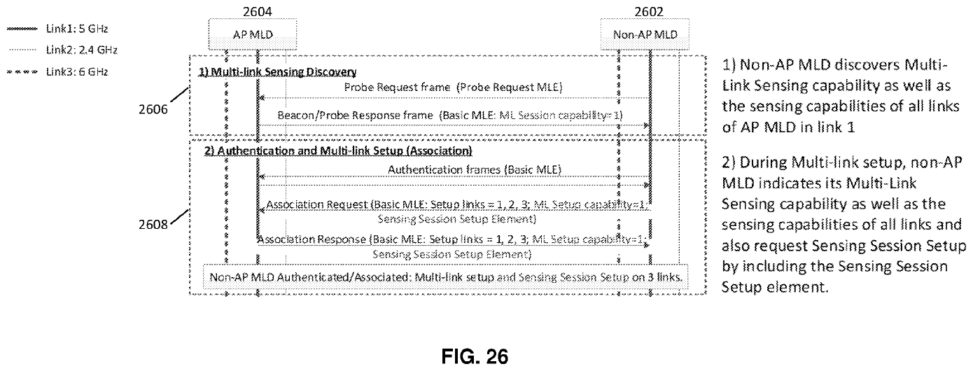

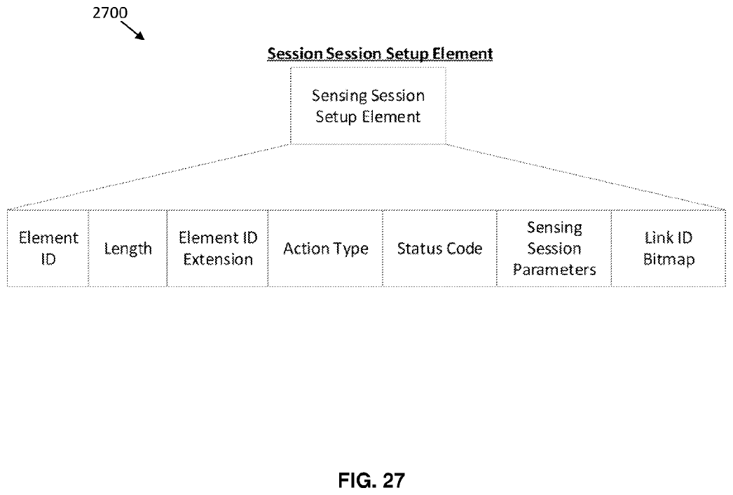

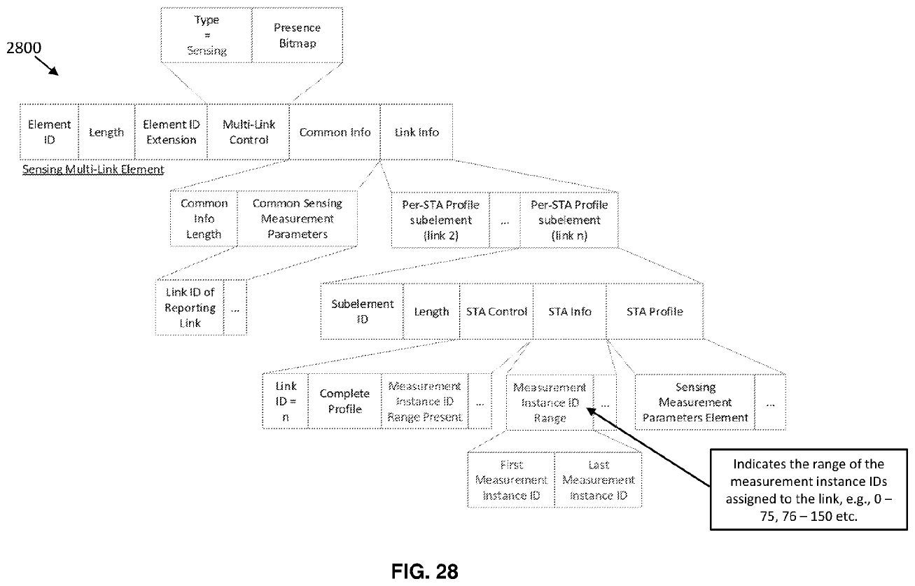

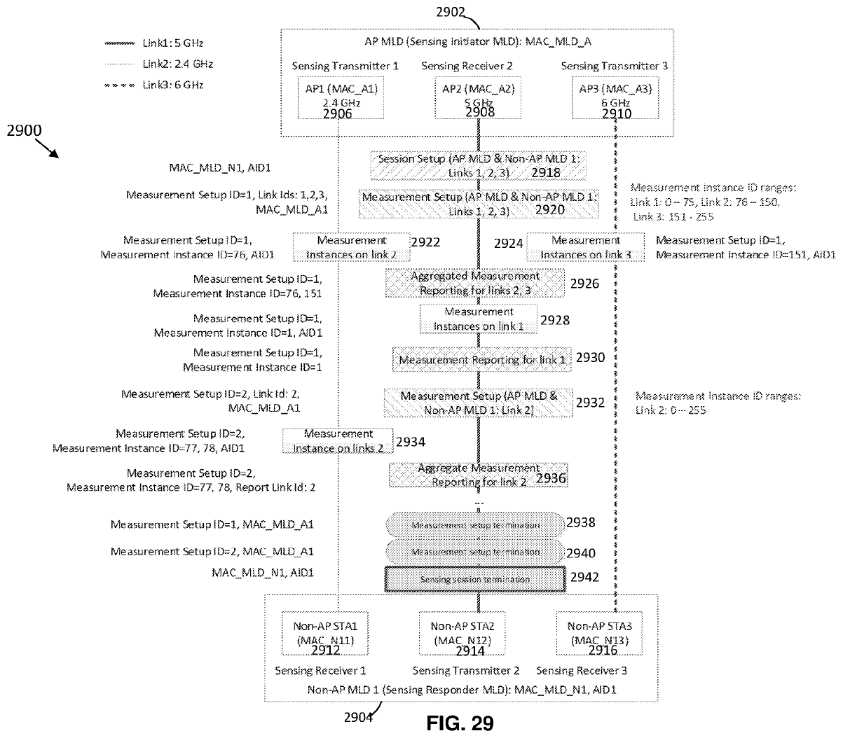

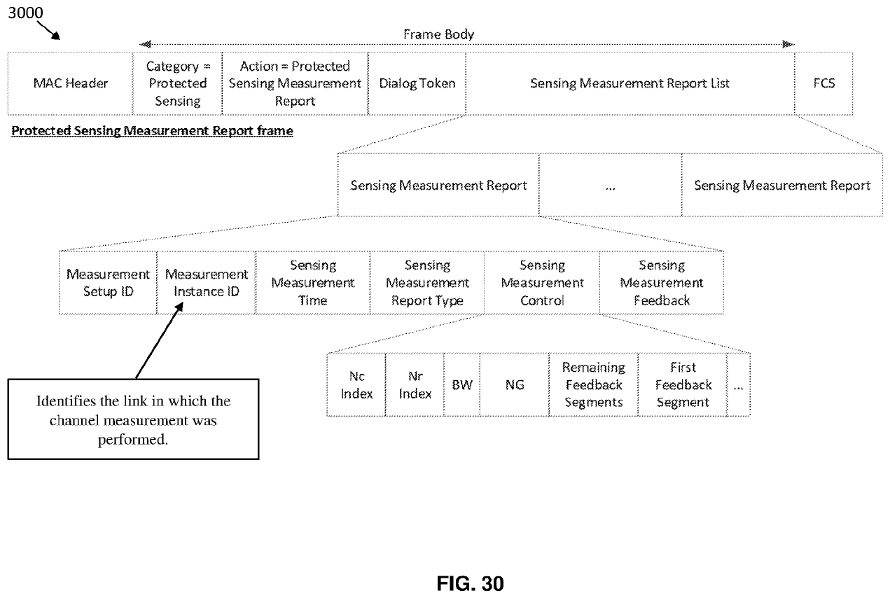

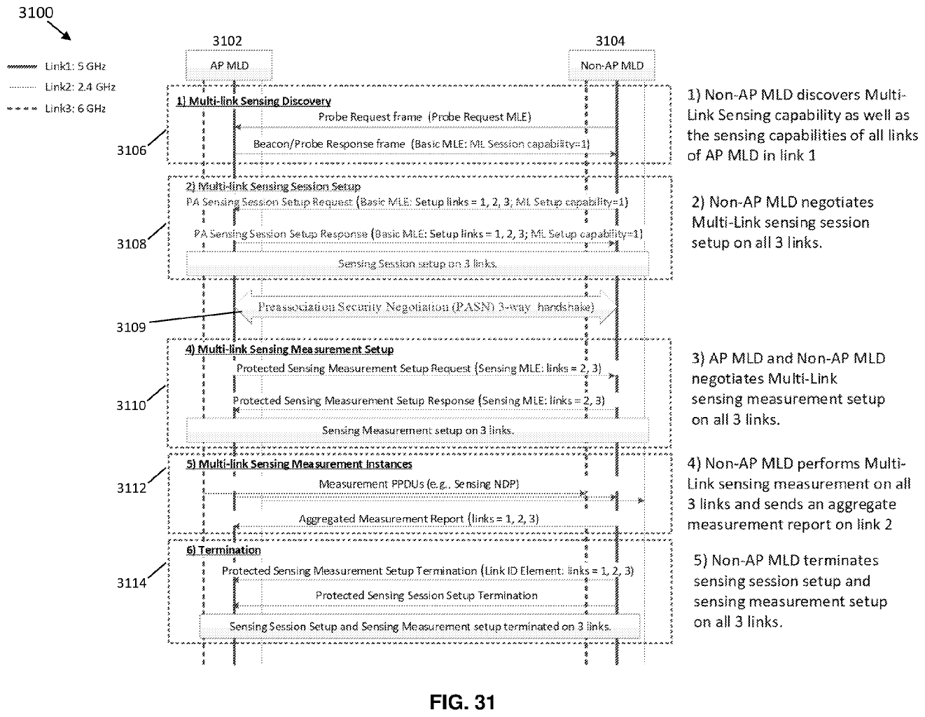

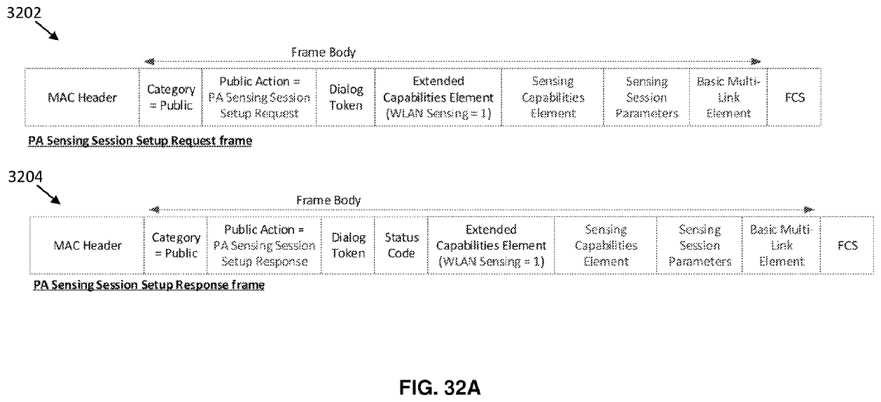

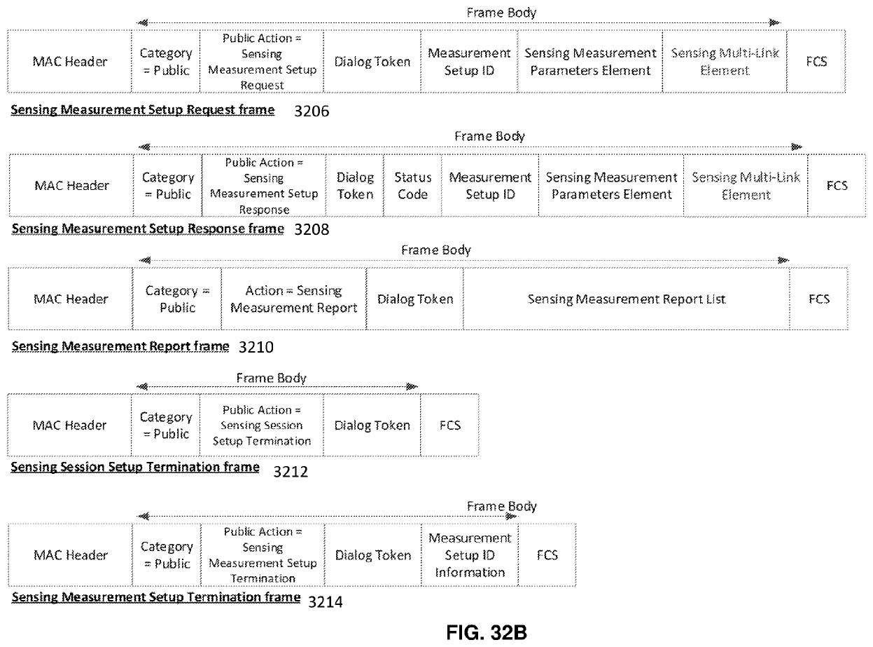

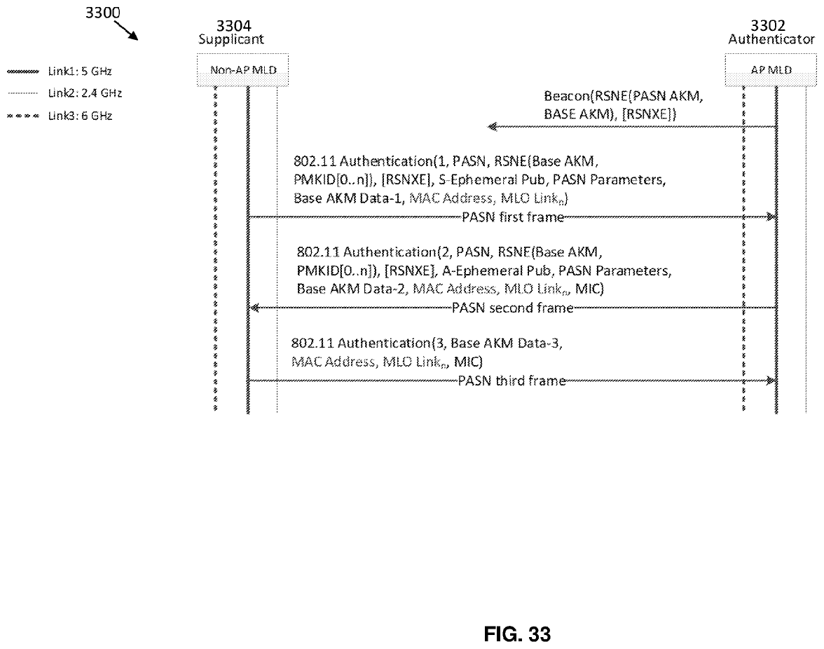

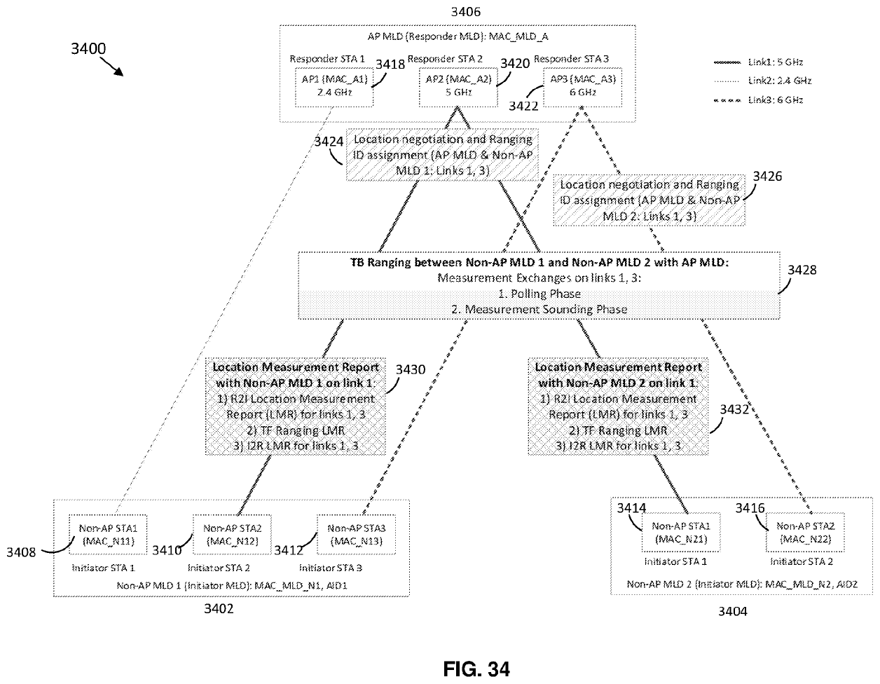

As mentioned above, the technical solutions provided in the present disclosure are not only applicable to multi-link WLAN sensing procedures (e.g., as depicted in FIG. 11), but also applicable to other WLAN applications such as multi-link WLAN ranging procedures. An alternative embodiment 3400 of the method 400 is depicted in FIG. 34. In the alternative embodiment 3400, the method 400 is implemented as a multi-link WLAN ranging procedure 3400 between two first MLDs 3402, 3404 and a second MLD 3406. Details of the multi-link WLAN ranging procedure 3400 are illustrated in FIG. 34 and described in the corresponding paragraphs.

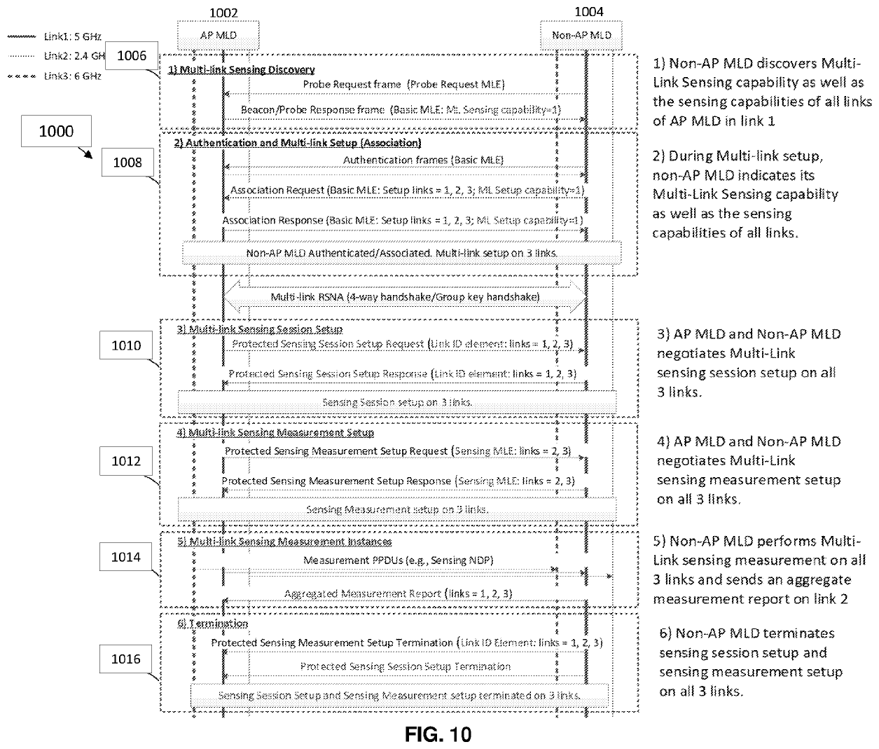

FIG. 12 illustrates an embodiment of a Basic Multi-Link element 1200 that can be used by the first MLD 1002 and/or the second MLD 1004 to indicate multi-link sensing capability of the first MLD 1002 and/or the second MLD 1004 in a multi-link sensing discovery 1008 of the multi-link WLAN sensing procedure 1000 as depicted in FIG. 10. The Basic Multi-Link element 1200 can be used in applicable frames such as Beacon, Probe Request/Response, Association Request/Response, etc.

FIG. 13A illustrates an embodiment of a Protected Sensing Session Setup Request frame 1300. FIG. 13B illustrates an embodiment of a Protected Sensing Session Setup Response frame 1350. In an embodiment, the Protected Sensing Session Setup Request frame 1300 and the Protected Sensing Session Setup Response frame 1350 are exchanged between the first MLD 1002 and the second MLD 1004 in a multi-link sensing setup 1010 of the multi-link WLAN sensing procedure 1000 as depicted in FIG. 10.

FIG. 13C illustrates an embodiment of a Link Info Element, which is carried in the frame body of the Protected Sensing Session Setup Request frame 1300 and/or the Protected Sensing Session Setup Response frame 1350.

FIG. 13D illustrates an embodiment of a Sensing Session Parameters, which is carried in the frame body of the Protected Sensing Session Setup Request frame 1300 and/or the Protected Sensing Session Setup Response frame 1350.

FIG. 14A illustrates an embodiment of a Protected Sensing Measurement Setup Request frame 1400. FIG. 14B illustrates an embodiment of a Protected Sensing Measurement Setup Response frame 1450. In an embodiment, the Protected Sensing Measurement Setup Request frame 1400 and the Protected Sensing Measurement Setup Response frame 1450 are exchanged between the first MLD 1002 and the second MLD 1004 in a multi-link sensing measurement setup 1012 of the multi-link WLAN sensing procedure 1000 as depicted in FIG. 10.

FIG. 14C illustrates an embodiment of a Sensing Measurement Parameters Element 1402, which is carried in the frame body of the Protected Sensing Measurement Setup Request frame 1400 and/or the Protected Sensing Measurement Setup Response frame 1450.

FIG. 14D illustrates an embodiment of a Sensing Multi-Link Element 1404, which is carried in the frame body of the Protected Sensing Measurement Setup Request frame 1400 and/or the Protected Sensing Measurement Setup Response frame 1450.

FIG. 15 illustrates embodiments of sensing roles, e.g., a sensing receiver or a sensing transmitter, that can be assigned to respective stations (STAs) affiliated with the first MLD 1002 and/or the second MLD 1004 in a multi-link sensing measurement setup 1012 of the multi-link WLAN sensing procedure 1000 as depicted in FIG. 10. It shows that different STAs affiliated with the same MLD 1002 or 1004 can be assigned with same or different sensing roles during the sensing measurement setup 1012.

FIG. 16 illustrates an embodiment of a Sensing Null Data Packet Announcement (NDPA) frame 1600.

FIG. 17 illustrates an embodiment of a Sensing Report Trigger frame 1700. In an embodiment, the NDPA frame 1600 and the Sensing Report Trigger frame 1700 are exchanged between the first MLD 1002 and the second MLD 1004 in a multi-link sensing measurement instance 1014 of the multi-link WLAN sensing procedure 1000 as depicted in FIG. 10.

FIG. 18 illustrates a flowchart illustrating an embodiment 1800 of the multi-link sensing measurement instance 1014. In this embodiment, the multi-link sensing measurement instance 1014 is a Trigger Based (TB) multi-link sensing measurement instance 1800 between a first MLD 1802 and a second MLD 1804.

FIG. 19 illustrates a flowchart illustrating another embodiment 1900 of the multi-link sensing measurement instance 1014. In this embodiment, the multi-link sensing measurement instance 1014 is a non-Trigger Based (non-TB) multi-link sensing measurement instance 1900 between a first MLD 1902 and a second MLD 1904.

FIG. 20 illustrates an embodiment of a Protected Sensing Measurement Report frame 2000. In an embodiment, the Protected Sensing Measurement Report frame 2000 is transmitted from a STA affiliated with a sensing responder MLD to a STA affiliated with an initiator MLD to provide results of channel measurements obtained from a sensing measurement instance operated on a corresponding link. The transmission of the Protected Sensing Measurement Report frame 2000 is done prior to a termination session 1016 of the multi-link WLAN sensing procedure 1000 as depicted in FIG. 10.

FIG. 21 illustrates an embodiment of a Protected Sensing Session Setup Termination frame 2100.

FIG. 22 illustrates an embodiment of a Protected Sensing Measurement Setup Termination frame 2200.

FIG. 23 illustrates a flowchart illustrating an embodiment 2300 showing generation and transmission of MAC Layer Management Entity (MLME) primitives taken place at a station management entity (SME) 2306 and a MLD MLME 2308 of a first MLD 2302 and at a station management entity (SME) 2312 and a MLD MLME 2310 of a second MLD 2304 during a non-Trigger Based (non-TB) multi-link sensing procedure 2314.

FIG. 24 illustrates a flowchart illustrating another embodiment 2400 showing generation and transmission of MAC Layer Management Entity (MLME) primitives taken place at a station management entity (SME) 2406 and a MLD MLME 2408 of a first MLD 2402 and at a station management entity (SME) 2412 and a MLD MLME 2410 of a second MLD 2404 during a Trigger Based (TB) multi-link sensing procedure 2414.

FIG. 25A depicts an exemplary multi-link WLAN sensing environment 2500 which comprises a first MLD 2502 and a second MLD 2504. In this embodiment, the first MLD 2502 is an AP MLD 2502 and the second MLD is a non-AP MLD 2504. The AP MLD 2502 and the non-AP MLD 2504 are configured to conduct a multi-link sensing procedure to detect features of an intended target 2506 through two WLAN sensing applications, e.g., Breathing estimation and Heart-rate estimation, in accordance with the embodiments of multi-link sensing procedure as described in the present disclosure.

FIG. 25B illustrates a flowchart illustrating an embodiment 2550 of a multi-link sensing procedure between the AP MLD 2502 and the non-AP MLD 2504 in the multi-link WLAN sensing system 2500.

FIG. 26 illustrates a block diagram depicting an alternative exemplary signaling process 2600 between a first MLD 2602 and a second MLD 2604 during a multi-link WLAN sensing procedure. In this alternative exemplary signaling process 2600, only a multi-link sensing discovery 2602 and an authentication and multi-link setup 2608 (i.e., an association process to associate the first MLD 2602 and the second MLD 2604) are depicted. In this embodiment, the multi-link sensing session setup 1010 as depicted in FIG. 10 is incorporated in the authentication and multi-link setup 2608 by including a Sensing Session Setup element in Association request/response frames.

For the sake of simplicity, the multi-link sensing measurement setup, multi-link sensing measurement instance, and termination processes are omitted in FIG. 26. It is understandable to those skilled in the art that the multi-link sensing measurement setup, multi-link sensing measurement instance, and termination processes can be same as those depicted in the other embodiments of the present disclosure.

FIG. 27 illustrates an embodiment of a Sensing Session Setup Element 2700, which can be included in Association request/response frames as described above, to achieve the multi-link sensing session setup in the authentication and multi-link setup 2608.

FIG. 28 illustrates another embodiment of a Sensing Multi-Link Element 2800. The Sensing Multi-Link Element 2800 is carried in the frame body of a Protected Sensing Measurement Setup Request frame as depicted in FIG. 14A and/or a Protected Sensing Measurement Setup Response frame as depicted in FIG. 14B.

FIG. 29 illustrates a flowchart illustrating another embodiment of a multi-link WLAN sensing procedure 2900 between a first MLD 2902 and a second MLD 2904. In this embodiment, due to the Sensing Multi-Link Element 2800 comprised in Protected Sensing Measurement Setup Request/Response frames that are exchanged between the first MLD 2902 and the second MLD 2904 during a multi-link sensing measurement setup, different links associated with respective sensing measurements are identified by the corresponding Measurement Instance IDs.

FIG. 30 illustrates another embodiment of a Protected Sensing Measurement Report frame 3000. The Protected Sensing Measurement Report frame 3000 is similar to the Protected Sensing Measurement Report frame 2000 depicted in FIG. 20, except that the Measurement Setup ID field and the Measurement Instance ID field in the Protected Sensing Measurement Report frame 3000 are now parallel to the sensing measurement control field in the sensing measurement report. Instead of a Measurement Link ID field used in the Protected Sensing Measurement Report frame 2000, the Protected Sensing Measurement Report frame 3000 uses the Measurement Instance ID field to identify the link in which the channel measurement was performed.

FIG. 31 illustrates a block diagram depicting an alternative exemplary signaling process 3100 between a first MLD 3102 and a second MLD 3104 during a multi-link WLAN sensing procedure according to an embodiment. In this alternative exemplary signaling process 3100, the first MLD 3102 and the second MLD 3104 are not yet associated prior to a multi-link sensing session setup 3108. As such, this embodiment 3100 of multi-link WLAN sensing procedure does not include the authentication and multi-link setup 1008 as depicted in FIG. 10. Instead, this embodiment 3100 of multi-link WLAN sensing procedure uses Preassociation (PA) Sensing Session Setup Request/Response frames exchanged between the first MLD 3102 and the second MLD 3104 in the multiple-link sensing session setup 3108, and includes an optional Preassociation Security Negotiation (PASN) 3109 process prior to the multi-link sensing measurement setup 3110.

FIG. 32A illustrates an embodiment of a PA Sensing Session Setup Request frame 3202 and an embodiment of a PA Sensing Session Setup Response frame 3204.

FIG. 32B illustrates an embodiment of a Sensing Measurement Setup Request frame 3206, an embodiment of a Sensing Measurement Setup Response frame 3208, an embodiment of a Sensing Measurement Report frame 3210, an embodiment of a Sensing Session Setup Termination frame 3212, and an embodiment of a Sensing Measurement Setup Termination frame 3214 to be used in the embodiment 3100 of multi-link WLAN sensing procedure. In these embodiments of frames, a public action field is used in the frame body if the optional PASN process is not setup prior to the multi-link sensing measurement setup 3110. Alternatively, a protected action field is used in the frame body if the optional PASN process is setup prior to the multi-link sensing measurement setup 3110.

FIG. 33 illustrates a flowchart showing an embodiment of the optional Preassociation Security Negotiation (PASN) process 3109 as depicted in FIG. 31. The process establishes a Pairwise Transient Key Security Association (PTKSA) and corresponding shared keys between a PASN capable non-AP MLD 3102, 3304 and an AP MLD 3104, 3302.

FIG. 34 illustrates a flowchart showing an alternative embodiment 3400 of the method 400. In the alternative embodiment 3400, the method 400 is implemented as a multi-link WLAN ranging procedure 3400 among two first MLDs 3402, 3404 and a second MLD 3406.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the exemplary embodiments or the application and uses of the exemplary embodiments. Furthermore, there is no intention to be bound by any theory presented in the preceding background or the following detailed description.

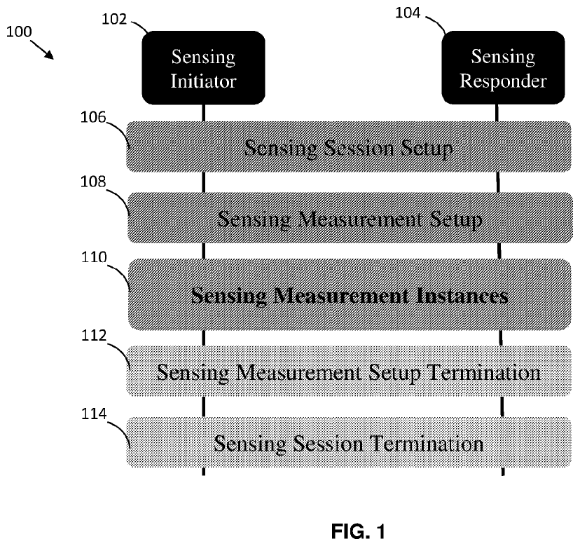

To facilitate understanding, FIG. 1 shows an exemplary WLAN sensing procedure 100 between a sensing initiator 102 and a sensing responder 104 as defined in 802.11bf. As shown, the exemplary WLAN sensing procedure 100 comprises five steps: a sensing session setup 106, a sensing measurement setup 108, a sensing measurement instance 110, a sensing measurement setup termination 112, and a sensing session termination 114. It is noted that while the actual channel measurements and the related transmissions (e.g., NDPA, NDP) in the sensing measurement instance 110 may be link specific, the rest of the sensing related procedures like the setups 106, 108, feedback reporting (i.e., sensing measurement reporting) in the sensing measurement instance 110, terminations 112, 114 etc. may be link agnostic and can benefit from multi-link operations.

However, in 802.11bf, the signalling in the exemplary WLAN sensing procedure 100 is between two standalone peer STAs (e.g., between a non-AP STA and an AP). If either one or both of the peer STAs is affiliated with an MLD, it is not clear whether the procedures will work as defined.

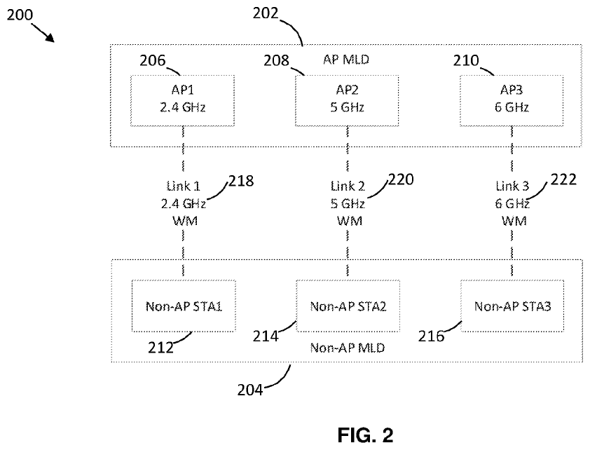

To facilitate understanding, FIG. 2 shows a schematic illustration 200 of multi-link communications between the affiliated APs 206, 208 and 210 of the AP MLD 202 and the affiliated non-AP STAs 212, 214 and 216 of the non-AP MLD 204 over multiple wireless links 218, 220, 222 as defined in 802.11be. 802.11be allows transmission of most types of management frames intended for an affiliated STA of an MLD via a different link of the same MLD, however, exact methods for identification of the intended STA are still under development.

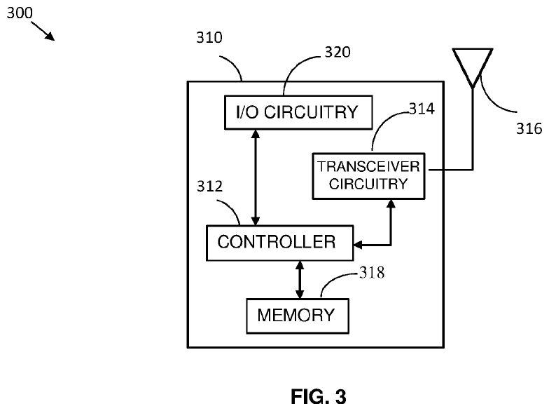

The above technical drawbacks have been overcome and a multi-link WLAN sensing procedure is provided by the embodiments of the present disclosure depicted in FIGS. 3 to 31, in which for a STA that is affiliated with an MLD, all measurement procedures (e.g., WLAN sensing procedures) except for the actual channel measurements and the related transmissions (e.g., of NDPA, NDP, Trigger Frame (TF)) are performed at the MLD level, e.g. at the MLD upper medium access control (MAC) layer. In this manner, all the multiple links are managed and utilised in a centralised and efficient manner at the MLD level. An efficient multi-link WLAN sensing procedure is thus advantageously achieved.

Advantageously, in addition to multi-link WLAN sensing procedures, since all the multiple links are managed and utilised in a centralised and efficient manner at the MLD level, the present application is further applicable to other WLAN applications such as multi-link WLAN ranging procedures.

FIG. 3 depicts a simplified block diagram 300 of an exemplary communication apparatus 310 that can be implemented as a first MLD or a second MLD in accordance with embodiments of the present disclosure based on practical requirements.

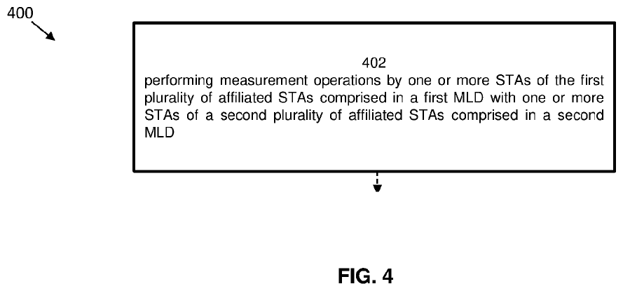

The communication apparatus 310 includes at least one transceiver 314 and circuitry. The circuitry may include one or more of components of the communication apparatus 310 as described below, e.g., a controller 312, etc. The transceiver works in conjunction with the circuitry, which in operation performs steps in accordance with embodiments of the method as shown in FIG. 4.

The transceiver 314 may comprise and/or function as a receiver and a transmitter. The transceiver, as the transmitter and receiver, may include a radio frequency (RF) module including amplifiers, RF modulators/demodulators and the like, and one or more antennas or interface (e.g. one or more connectors) to one or more antennas 316.

The communication apparatus 310 may further include a device such as a controller 312 which is coupled to a wireless communication device, such as the transceiver 314, connected to an antenna 316 for performing a function of communication as described in the present disclosure. For example, the communication apparatus 310 may comprise the controller 312 that generates control signals and/or data signals which are used by the transceiver 314 to perform a communication function of the communication apparatus 310.

The communication apparatus 310 may also comprise a memory 318 coupled to the controller 312 for storage of instructions and/or data for generation of the control signals and/or data signals by the controller 312. The communication apparatus 310 may also include input/output (I/O) circuitry 320 coupled to the controller 312 for receiving input of data and/or instructions for storage in the memory 318 and/or for generation of the control signals and/or data signals and for providing output of data in the form of audio, video, textual or other media.

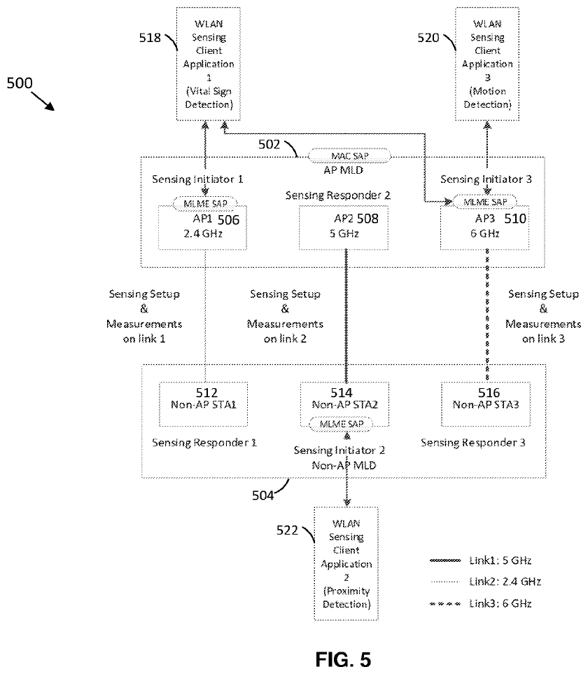

As described above, the communication apparatus 310 can be implemented as a first MLD or a second MLD that is capable of multiple link operations (MLO). Each link of the first MLD or the second MLD is regarded as a link between the station (STA) affiliated with the first MLD and the STA affiliated with the second MLD. Accordingly, the first MLD or the second MLD comprises a plurality of affiliated STAs. For the sake of simplicity, the plurality of affiliated STAs are not depicted in FIG. 3. Embodiments of the first MLD with a first plurality of STAs or the second MLD with a second plurality of STAs are depicted in FIGS. 5-34.

FIG. 4 illustrates a flowchart illustrating a method 400 implemented by a first MLD for multi-link WLAN measurement procedures in accordance with embodiments of the present disclosure. For multi-link WLAN measurement procedures of the present application, the first MLD is an initiator MLD that initiates a sensing or ranging session between two MLDs. In the initiator MLD, at least one of the first plurality of affiliated STAs is configured as an initiator STA, e.g., a sensing initiator (in a multi-link WLAN sensing procedure) or a ranging initiator (in a multi-link WLAN ranging procedure). In some embodiments, the initiator MLD is an AP MLD and each of the first plurality of affiliated STAs is an AP. In some other embodiments, the initiator MLD can be a non-AP MLD and each of the first plurality of affiliated STAs can be a non-AP STA.

Similarly, in multi-link WLAN measurement procedures of the present application, the second MLD is a responder MLD that participates in a sensing or ranging session initiated by the first MLD. In the responder MLD, at least one of the second plurality of affiliated STAs acts as a responder STA, e.g. a sensing responder (in a multi-link WLAN sensing procedure) or a ranging responder (in a multi-link WLAN ranging procedure). In some embodiments, the responder MLD is a non-AP MLD and each of the second plurality of affiliated STAs is a non-AP STA. In some other embodiments, the responder MLD can be an AP MLD and each of the second plurality of affiliated STAs can be an AP.

As shown in FIG. 4, at step 402, the at least one transceiver of the first MLD works in conjunction with the circuitry, which in operation enables one or more STAs of the first plurality of affiliated STAs comprised in the first MLD to perform measurement operations with one or more STAs of a second plurality of affiliated STAs comprised in a second MLD.

FIG. 5 illustrates a schematic illustration of an embodiment 500 in which the method 400 is implemented as a multi-link WLAN sensing procedure 500 between a first MLD 502 and a second MLD 504 implemented by the communication apparatus 310.

In the embodiment 500, the first MLD 502 comprises a first plurality of affiliated STAs 506, 508, 510. The second MLD 504 comprises a second plurality of affiliated STAs 512, 514, 516. In this embodiment, the first MLD 502 is an AP MLD with its affiliated STAs 506, 508, 510 being all APs. The second MLD 504 is a non-AP MLD with its affiliated STAs 512, 514, 516 being all non-AP STAs.

In this embodiment, there are three links between the first MLD 502 and the second MLD 504, i.e., Link 1 between AP 508 and non-AP STA 514 in the 5 GHz band, Link 2 between AP 506 and non-AP STA 512 in the 2.4 GHz band, and Link 3 between AP 510 and non-AP STA 516 in the 6 GHz band. It is understandable to those skilled in the art that the number of the links and their respective frequency bands can vary based on the practical needs and requirements.

In this embodiments, multi-link WLAN sensing is controlled by upper layer applications, e.g., WLAN sensing applications 518, 520, 522, and is transparent at the 802.11 MAC/PHY layers. The upper layer applications directly communicate with each of the affiliated STAs 506, 508, 510, 512, 514, 516 of the first and second MLDs 502, 504. The upper layer applications are responsible for controlling the affiliated STAs to perform sensing measurements and collecting sensing reports on each link, i.e., Link 1, Link 2, or Link 3.

In the embodiment 500, while sensing setup and measurements are performed on multiple links between multiple pairs of STAs between the first MLD 502 and the second MLD 504, the setup and measurements are performed independently for each pair of STAs. That is, in this embodiment, each of the affiliated STAs 506, 508, 510 of the first MLD 502 and the affiliated STAs 512, 514, 516 of the second MLD 504 is configured to communicate independently with WLAN sensing applications 518, 520, 522 to perform WLAN measurements independently on each link, i.e., Link 1, Link 2, or Link 3. In a multi-link WLAN sensing procedure, each of the affiliated STAs 506, 508, 510 of the first MLD 502 and the affiliated STAs 512, 514, 516 of the second MLD 504 is configured to work independently as a sensing initiator or a sensing responder on the respective links as requested by the respective WLAN sensing applications 518, 520, 522.

For example, as shown in FIG. 5, a vital sign detection application 518 runs on top of the first MLD 502 and uses channel measurements on Links 2 and 3. In this regard, the vital sign detection application 518 directly works with AP 506 and AP 510 via each AP's MLME SAPs to set up AP 506 and AP 510 as sensing initiators and non-AP STA 512 and non-AP STA 516 as sensing responders on Link 2 and Link 3 respectively. Similarly, a motion detection application 520 also runs on top of the first MLD 502 and uses channel measurements on Link 3. In this regard, the motion detection application 520 directly works with AP 510 via the AP's MLME SAPs to set up AP 510 as sensing initiators and non-AP STA 516 as sensing responder on Link 3. Similarly, a proximity detection application 522 runs on top of the second MLD 504 and uses channel measurements on Link 1. In this regard, the proximity detection application 522 directly works with non-AP STA 514 via the non-AP STA's MLME SAPs to set up non-AP STA 514 as sensing initiators and AP 508 as sensing responders on Link 1.

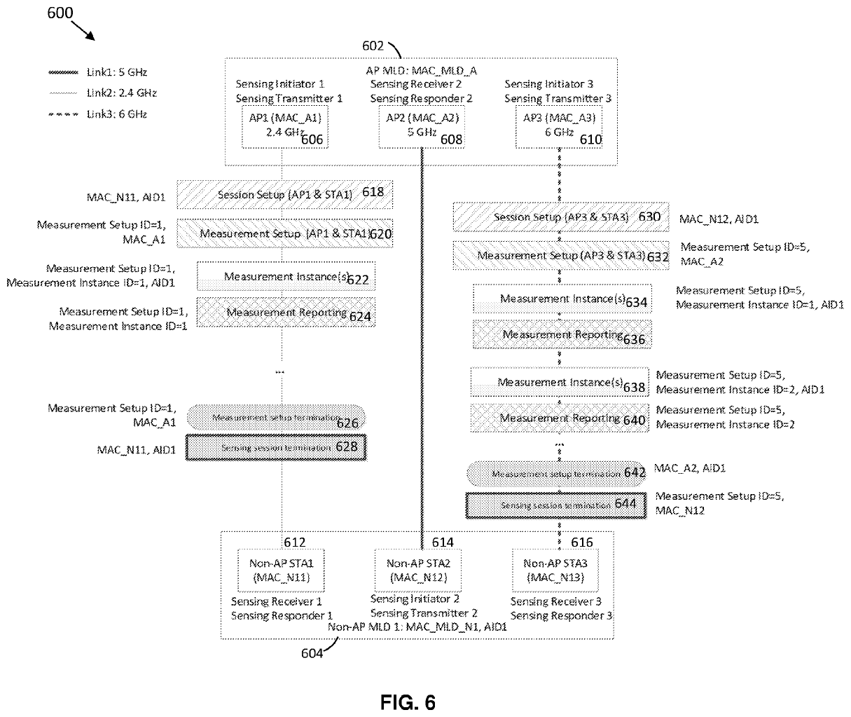

FIG. 6 illustrates a flowchart illustrating an embodiment 600 of the multi-link WLAN sensing procedure 500 between a first MLD 602 and a second MLD 604.

In the embodiment 600, the first MLD 602 comprises a first plurality of affiliated STAs 606, 608, 610. The second MLD 604 comprises a second plurality of affiliated STAs 612, 614, 616. In this embodiment, the first MLD 602 is an AP MLD with its affiliated STAs 606, 608, 610 being all APs. The second MLD 604 is a non-AP MLD with its affiliated STAs 612, 614, 616 being all non-AP STAs.

In this embodiment, there are three links between the first MLD 602 and the second MLD 604, i.e., Link 1 between AP 608 and non-AP STA 614 in the 5 GHz band, Link 2 between AP 606 and non-AP STA 612 in the 2.4 GHz band, and Link 3 between AP 610 and non-AP STA 616 in the 6 GHz band. It is understandable to those skilled in the art that the number of the links and their respective frequency bands can vary based on the practical needs and requirements.

As shown in FIG. 5, WLAN sensing procedures on a link, e.g., Link 2, is independent of WLAN sensing procedures on another link, e.g., Link 3, in the embodiment 600. An exemplary multi-link WLAN sensing procedure comprises a WLAN sensing procedure performed between the AP 606 and the non-AP STA 612 on Link 2 that comprises a session setup 618, a measurement setup 620, a measurement instance 622, a measurement reporting 624, a measurement setup termination 626 and sensing session termination 628, and another WLAN sensing procedure performed independently performed between the AP 610 and the non-AP STA 616 on Link 3 that comprises a session setup 630, a measurement setup 632, a measurement instance 634, a measurement reporting 636, another measurement instance 638, another measurement reporting 640, a measurement setup termination 642 and sensing session termination 644. As shown in the exemplary multi-link WLAN sensing procedure, a sensing measurement is reported on the same link in which the sensing measurement is performed in the embodiment 600.

In the embodiment 600, while multiple concurrent sensing on multiple channels/links are made possible, there are duplicated setup and termination signaling on each link. In addition, link diversity provided by the multiple links in various frequency bands are not utilised in the embodiment 600. For example, links with a broader frequency spectrum are more suitable than other links for high density deployments, such as measurement reportings which tend to be data heavy, due to its greater number of non-overlapping channels. Alternatively, to save the overhead of explicit Sensing Session setups, it is also possible that, the first Sensing Measurement Setup Request/Response frames exchanged between two MLDs on a link also starts a Sensing Session between the two STAs operating on that link. Or, it is also possible that, the first Sensing Measurement Setup Request/Response frames exchanged between two MLDs on any one link also starts a Sensing Session between the two MLDs and further Sensing Sessions need not be setup on the other links.

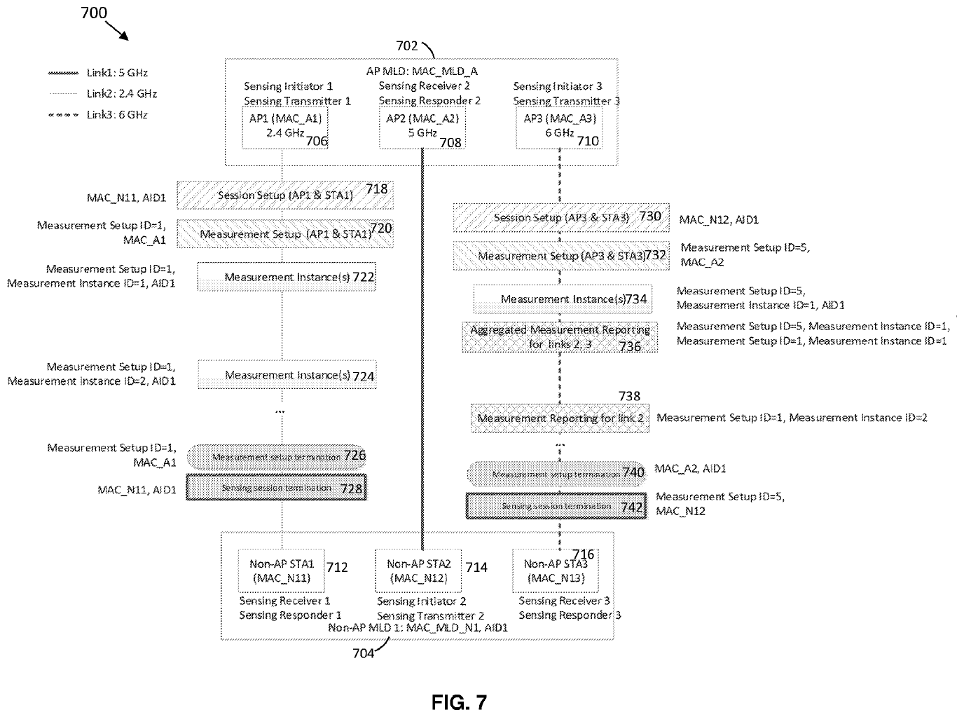

FIG. 7 illustrates a flowchart illustrating another embodiment 700 that makes improvements on the embodiment 600.

In this embodiment, the method 400 is also implemented as a multi-link WLAN sensing procedure 700 between a first MLD 702 and a second MLD 704. The first MLD 702 comprises a first plurality of affiliated STAs 706, 708, 710. The second MLD 704 comprises a second plurality of affiliated STAs 712, 714, 716. In this embodiment, the first MLD 702 is an AP MLD with its affiliated STAs 706, 708, 710 being all APs. The second MLD 704 is a non-AP MLD with its affiliated STAs 712, 714, 716 being all non-AP STAs.

In this embodiment, there are three links between the first MLD 702 and the second MLD 704, i.e., Link 1 between AP 708 and non-AP STA 714 in the 5 GHz band, Link 2 between AP 706 and non-AP STA 712 in the 2.4 GHz band, and Link 3 between AP 710 and non-AP STA 716 in the 6 GHz band. It is understandable to those skilled in the art that the number of the links and their respective frequency bands can vary based on the practical needs and requirements.

In addition to same link reporting in the embodiment 600, the embodiment 700 allows cross-link reporting, i.e., sensing measurement reports of one link may be transmitted on another link, and aggregated reporting, i.e., multiple sensing measurement reports of different links may be aggregated and transmitted on one link. The cross-link reporting and the aggregated reporting are depicted in FIG. 7 by an exemplary multi-link WLAN sensing procedure that comprises a WLAN sensing procedure performed between the AP 706 and the non-AP STA 712 on Link 2 that comprises a session setup 718, a measurement setup 720, a measurement instance 722, another measurement instance 724, a measurement setup termination 726 and a sensing session termination 728, and another WLAN sensing procedure performed independently performed between the AP 710 and the non-AP STA 716 on Link 3 that comprises a session setup 730, a measurement setup 732, a measurement instance 734, an aggregated measurement reporting 736, another measurement reporting 738, a measurement setup termination 740 and a sensing session termination 742. In this embodiment, the aggregated measurement reporting 736 is an aggregated-link reporting on Link 3 for reporting the measurements performed on Link 2 and Link 3 (for measurement instances 722 and 734). The measurement reporting 738 is a cross-link reporting on Link 3 for reporting the measurement performed on Link 2 (for measurement instances 724).

In this manner, the embodiment 700 utilises the link diversity provided by the multiple links in various frequency bands. However, there still are duplicated setup and termination signaling on each link.

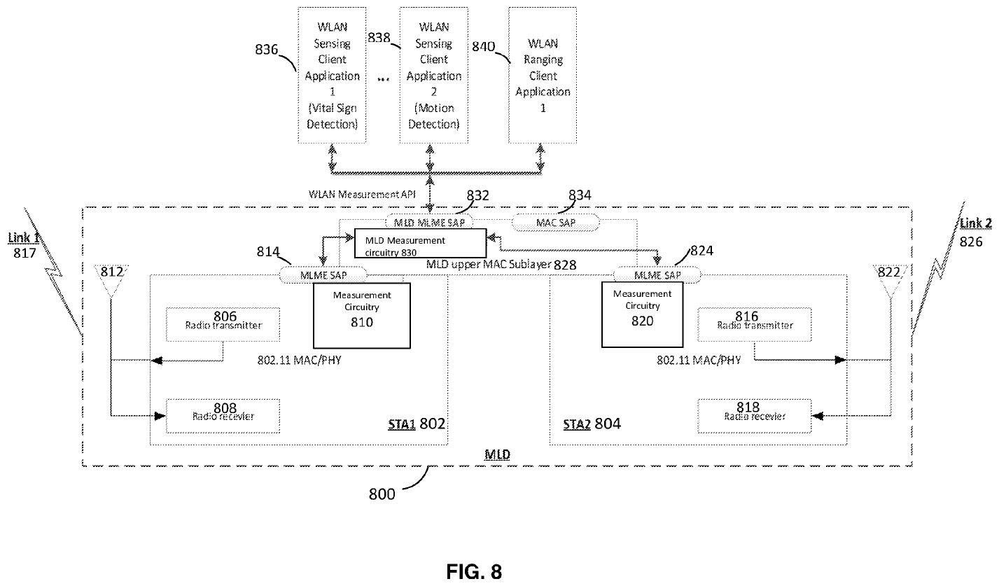

The following embodiments depicted in FIGS. 8 to 34 have made further improvements to the embodiments 500, 600 and 700, which now advantageously remove duplicated setup and termination signaling and fully utilise the link diversity provided by the multiple links in various frequency bands.

FIG. 8 depicts a block diagram of an embodiment 800 of the exemplary communication apparatus 300. In this embodiment 800, the communication apparatus is implemented as a first MLD 800 which can communicate with a plurality of upper layer applications. As an example, the plurality of upper layer applications comprise a first WLAN sensing client application 836 for vital sign detection, a second WLAN sensing client application 838 for motion detection, and a WLAN ranging client application 840.

It is understandable to those skilled in the art that the embodiment 800 can also be implemented as a second MLD in accordance with embodiments of the present disclosure based on practical requirements.

In the present embodiment, the first MLD 800 comprises a first plurality of affiliated STAs. In this embodiment, the first plurality of affiliated STAs include two affiliated STAs 802 and 804. It is understandable to those skilled in the art, that the first plurality of affiliated STAs may include more than two STAs based on practical requirements.

In the present embodiment, the at least one transceiver of the first MLD 800 is implemented as a set of radio transmitter 806, a radio receiver 808 and an antenna 812 in the affiliated STA 802 and a set of radio transmitter 816, a radio receiver 818 and an antenna 822 in the affiliated STA 804.

In the present embodiment, each of the first plurality of affiliated STAs 802 and 804 comprises a measurement circuitry 810, 820 and a MAC Layer Management Entity (MLME) service access point (SAP) 814, 824, which are used for performing link specific measurement operations. As shown in FIG. 8, the radio transmitter 806, 816, the radio receiver 808, 818, and the measurement circuitry 810, 820 at each of the affiliated STAs 802 and 804 are managed at 802.11 MAC or PHY layer. The MLME SAP 814, 824 are interfaces for the first plurality of affiliated STAs 802 and 804 to communicate with the first MLD 800 at MLD upper MAC sublayer 828.

The first MLD 800 further comprises a MLD measurement circuitry 830 and a MLD control circuitry (not shown in FIG. 8 for the sake of simplicity) managed at the MLD upper MAC sublayer 828. The MLD measurement circuitry 830 communicates with the measurement circuitry 810, 820 of the STAs 802, 804 via the MLME SAP 814, 824 and manages all multi-link measurement related MLMEs at the MLD level. The MLD control circuitry handles management of multiple links (e.g., selection of links for setup etc) for the STAs 802, 804 at the MLD level in a similar manner.

FIG. 4 illustrates a flowchart illustrating a method 400 implemented by the first MLD 800 for multi-link WLAN sensing or ranging procedures in accordance with an embodiment of the present disclosure.

As described above, the first MLD 800 comprises at least one transceiver, and circuitry. As depicted in step 402 of FIG. 4, the at least one transceiver works in conjunction with the circuitry, which in operation enables one or more STAs of the first plurality of affiliated STAs 802, 804 to perform measurement operations with one or more STAs of a second plurality of affiliated STAs comprised in a second MLD (not shown in FIG. 8 for the sake of simplicity).

As shown in FIG. 8, the first MLD 800 further comprises a MLD MLME SAP 832 and a MAC SAP 834. The MLD MLME SAP 832 is a single interface for the first MLD 800 to communicate with the upper layer applications as described above, e.g. the first WLAN sensing client application 836 for vital sign detection, the second WLAN sensing client application 838 for motion detection, and the WLAN ranging client application 840. The upper layer applications 836, 838, 840 configure the one or more STAs of the first plurality of affiliated STAs 802, 804, via the MLD MLME SAP 832 to perform measurement operations with the one or more STAs of the second plurality of affiliated STAs comprised in the second MLD over one or more links 816, 826.

The upper layer applications 836, 838, 840 may request measurement over one or more links 817, 826 to the MLD measurement circuitry 830 via the MLD MLME SAP 832. The upper layer applications 836, 838, 840 may obtain measurement results from the MLD measurement circuitry 830 via the MLD MLME SAP 832, process the results for applications, and/or transfer the results to other server(s), remote applications, and/or cloud services via the communication link 817,826, local area network (LAN), internet of things (IoT) network, cellular network, and/or Internet, etc.

In some embodiments, the measurement operations comprise one or more of a sensing measurement, ranging measurement and/or a fine time measurement (FTM).

In some embodiments, a STA of the first plurality of affiliated STAs 802, 804 transmits a request frame to a STA of the second plurality of affiliated STAs to request a measurement setup procedure or a measurement termination procedure. Embodiments of the request frame are depicted in FIGS. 13A to 13D, 14A to 14D, 21 to 22 and 32A to 32B.

The measurement setup procedure allows the measurement operations to be performed on one or more links 816, 826 established between the first MLD 800 and the second MLD. The measurement termination procedure terminates the measurement setup established between the first MLD 800 and the second MLD. As described above, the measurement setup procedure or the measurement termination procedure can be used for a multi-link WLAN sensing procedure or a multi-link WLAN ranging procedure.

As described above, for multi-link WLAN sensing procedures of the present application, the first MLD 800 is a sensing initiator MLD that initiates a sensing session between two MLDs. In the sensing initiator MLD 800, at least one of the first plurality of affiliated STAs 802, 804 is configured as a sensing initiator. In some embodiments, the sensing initiator MLD 800 is an AP MLD and each of the first plurality of affiliated STAs 802, 804 is an AP. In some other embodiments, the sensing initiator MLD 800 can be a non-AP MLD and each of the first plurality of affiliated STAs 802, 804 can be a non-AP STA.

Likewise, in multi-link WLAN sensing procedures of the present application, the second MLD is a sensing responder MLD that participates in a sensing session initiated by the first MLD 800. In a sensing responder MLD, at least one of the second plurality of affiliated STAs acts as a sensing responder. In some embodiments, the sensing responder MLD is a non-AP MLD and each of the second plurality of affiliated STAs is a non-AP STA. In some other embodiments, the sensing responder MLD can be an AP MLD and each of the second plurality of affiliated STAs can be an AP.

In some embodiments of a multi-link WLAN sensing procedure, the measurement setup procedure comprises one of a sensing session setup or a sensing measurement setup. For multi-link measurements, the sensing session setup is also referred to as a multi-link sensing session setup. The sensing measurement setup is also referred to as a multi-link sensing measurement setup.

The sensing session setup is configured to identify the one or more links 816, 826 established between the first MLD 800 and the second MLD for one or more sensing operations performed thereon. In other words, the sensing session setup establishes a multi-link sensing session between the first MLD 800 and the second MLD (instead of multiple sensing sessions between multiple pairs of affiliated STAs as depicted in FIGS. 5-7). A multi-link sensing session is pairwise on the MLD level and is identified by a MLD MAC Address and/or associated AID/UID (which are same for all affiliated STAs of a non-AP MLD) of a peer MLD, i.e. the sensing sessions at an AP MLD are identified with the non-AP MLDs' MLD MAC Address and/or AID/UID, while the sensing sessions at a non-AP MLD are identified with the AP MLDs' MLD MAC Address.

The sensing measurement setup is used to negotiate sensing operation attributes for each of the one or more of the identified links 817, 826. In other words, a sensing measurement setup allows the first MLD 800 (i.e., a sensing initiator MLD) and a second MLD (i.e., a sensing responder MLD) to exchange and agree on sensing operational attributes associated with one or more sensing measurement instances (one per link). The sensing operational attributes (i.e. operation parameters) for different links may be same or different.

In some embodiments, a sensing measurement setup is identified with a same measurement setup identifier (ID) on one or more of the identified links 817, 826. For each of the one or more of the identified links 817, 826, a link ID of each of the one or more of the identified links 817, 826 together with the measurement setup ID is used to identify the sensing operation attributes specific to the each of the one or more of the identified links 817, 826. In other words, one or more links can be associated with a single multi-link sensing measurement setup. The sensing measurement setup for one or more links may be performed over any one link among multiple links. However, the sensing measurement setup operation attributes are link specific and the operation attributes of a link are identified by a tuple <Sensing Initiator's MLD MAC Address, Measurement Setup ID, Link ID>.

In some embodiments, the sensing operation attributes comprise sensing transmitter or receiver roles, measurement report type, and sampling rate on each of the one or more of the identified links 817, 826. A sensing transmitter is a STA that transmits PPDUs used for sensing measurements in a multi-link WLAN sensing procedure. A sensing receiver is a STA that receives PPDUs sent by a sensing transmitter and performs sensing measurements in a multi-link WLAN sensing procedure. An affiliated STA of the first MLD 800 (i.e., sensing initiator MLD) can act as a sensing transmitter, a sensing receiver, both or neither in a sensing session. Likewise, an affiliated STA of the second MLD (i.e., sensing responder MLD) can act as a sensing receiver, a sensing transmitter, both or neither in a sensing session. In a same multi-link measurement setup, the sensing transmitter and sensing receiver roles of different affiliated STAs (or links) may be same or different. Embodiments of the sensing transmitter or receiver roles are depicted in FIG. 15.

In some embodiments, a sensing measurement instance of a sensing measurement setup is identified with a same measurement instance identifier (ID) on one or more of the identified links 817, 826. For each of the one or more of the identified links 817, 826, a link ID of each of the one or more of the identified links 817, 826 together with the measurement instance ID is used to identify a sensing measurement instance specific to each of the one or more of the identified links 817, 826.

In some embodiments, sensing measurement instances for multiple links can be triggered simultaneously (e.g., by upper layer signaling) but the actual transmission of measurement PPDUs on each link may start at different times due to channel access delays. Sensing measurement reports of one link may be transmitted on another link. Multiple sensing measurement reports of different links may be aggregated and transmitted on one link. The measurement instance ID is used to identify the sensing measurement instance that utilizes attributes of the same tuple <Sensing Initiator's MLD MAC Address, Measurement Setup ID>. A same measurement instance ID is used on all links for sensing measurement instances that are initiated at the same time.

In some embodiments, the first MLD 800 is configured to initiate a sensing measurement instance with the second MLD by transmitting a measurement PHY protocol data unit (PPDU) on a first link, e.g. link 817, of the identified links 817, 826 and requesting a STA affiliated with the second MLD operating on the first link, e.g. link 817, to perform sensing measurements on the measurement PPDU and another STA affiliated with the second MLD operating on a second link of the identified links to transmit a sensing measurement report on the second link. In these embodiments, the sensing measurement report carries a result of the sensing measurement performed on the first link, and a STA affiliated with the first MLD operating on the second link is configured to receive the sensing measurement report. In some embodiments, the second link can be same as the first link, e.g., link 817, or can be another link 826 of the identified links 817, 826.

In some embodiments, the first MLD 800 is configured to initiate a sensing measurement instance with the second MLD by transmitting a plurality of measurement PPDUs on a first set 817, 826 of links of the identified links (e.g. 816, 826 and more links that are not illustrated in FIG. 8) and requesting STAs affiliated with the second MLD operating on the first set 817, 826 of links to perform sensing measurements on the plurality of measurement PPDUs and to transmit a set of sensing measurement reports on a second link of the identified links (e.g., 817, 826 and more links that is not illustrated in FIG. 8). In these embodiments, the set of sensing measurement reports carry a set of results of the sensing measurements performed on the first set 817, 826 of links of the identified links (e.g., 817, 826 and more links that is not illustrated in FIG. 8), and a STA affiliated with the first MLD operating on the second link is configured to receive the set of sensing measurement reports. In these embodiments, the second link can be one of the first set 817, 826 of links or other than those in the first set of links (i.e., which is among the more links that are not illustrated in FIG. 8).

In the above embodiments, the second link is indicated in a null data packet announcement (NDPA) frame or a Trigger frame of the measurement PPDU or the plurality of measurement PPDUs.

In some embodiments, the measurement termination procedure comprises one of a sensing session termination or a sensing measurement termination.

In some embodiments of a multi-link WLAN ranging procedure, the measurement setup procedure comprises a location negotiation and ranging identifier (ID) assignment procedure. An embodiment of a multi-link WLAN ranging procedure is depicted in FIG. 31.

As described above, the embodiment 800 can also be implemented as a second MLD that works corresponding to the first MLD in a multi-link WLAN sensing procedure or a multi-link WLAN ranging procedure in accordance with embodiments of the present disclosure based on practical requirements.

In some embodiments, the embodiment 800 is implemented as a second multi-link device (MLD) comprising a second plurality of affiliated stations (STAs), wherein the second MLD comprises at least one transceiver, and circuitry, wherein the at least one transceiver works in conjunction with the circuitry, which in operation enables at least one STA of the second plurality of affiliated STAs to receive a request frame from at least one STA of a first plurality of affiliated STAs comprised in a first MLD. The request frame is configured to request a measurement setup procedure or a measurement termination procedure. The measurement setup procedure is configured to allow measurement operations to be performed on one or more links established between the first MLD and the second MLD. The measurement termination procedure is configured to terminate the measurement setup established between the first MLD and the second MLD.

In some embodiments of the second MLD, the measurement operations comprise one or more of a sensing measurement, a ranging measurement, and/or a fine time measurement (FTM). The measurement setup procedure comprises one of a sensing session setup or a sensing measurement setup. The measurement termination procedure comprises one of a sensing session termination or a sensing measurement termination.

In some embodiments, the second MLD is configured to participate in a sensing measurement instance initiated by the first MLD on a first link of the one or more links between the first MLD and the second MLD. A STA affiliated with the second MLD operating on the first link is configured to receive a measurement PPDU from the first MLD on the first link and performs sensing measurement. A STA affiliated with the second MLD operating on a second link of the one or more links is configured to transmit a sensing measurement report on the second link. The sensing measurement report carries a result of the sensing measurement performed on the first link. In some embodiments, the second link can be same as the first link, or can be another link of the one or more links.

In some embodiments, the second MLD is configured to participate in a sensing measurement instance initiated by the first MLD on a first set of links of the one or more links between the first MLD and the second MLD. STAs affiliated with the second MLD operating on the first set of links are configured to receive a plurality of measurement PPDUs from the first MLD on the first set of links and performs sensing measurement. A STA affiliated with the second MLD operating on a second link of the one or more links is configured to transmit a single sensing measurement report frame on the second link. In these embodiments, the single sensing measurement report frame carries results of the sensing measurement performed on the first set of links, and the second link is one of the first set of links or other than those in the first set of links.

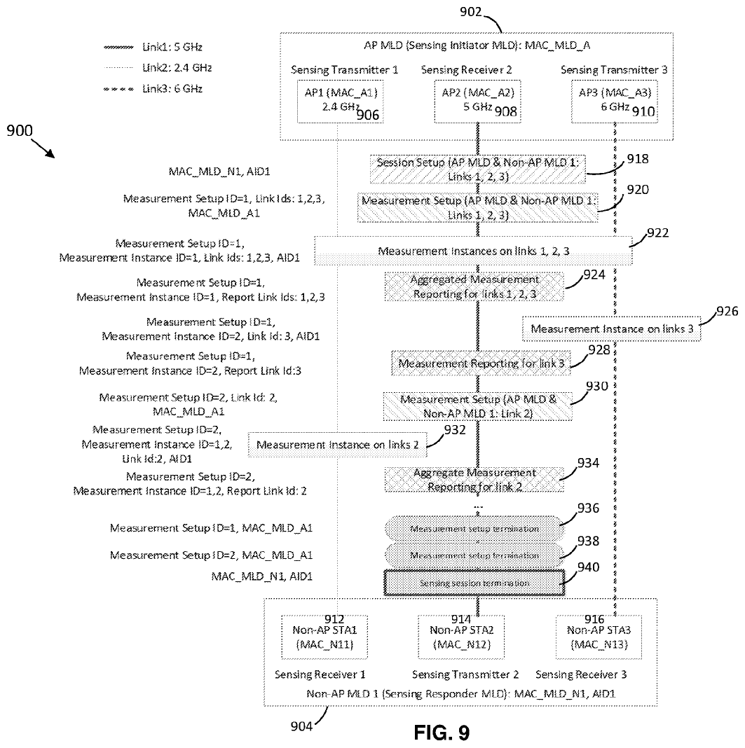

FIG. 9 illustrates a flowchart illustrating another embodiment 900 in which the method 400 is implemented as a multi-link WLAN sensing procedure 900 between a first MLD 902 and a second MLD 904 implemented by embodiment 800 of the exemplary communication apparatus 310.

In this embodiment, the first MLD 902 is AP MLD that comprises three APs 906, 908, 910. The second MLD 904 is a non-AP MLD that comprises three non-AP STAs 912, 914, 916. There are three links between the first MLD 902 and the second MLD 904, i.e., Link 1 between AP 608 and non-AP STA 614 in the 5 GHz band, Link 2 between AP 606 and non-AP STA 612 in the 2.4 GHz band, and Link 3 between AP 910 and non-AP STA 916 in the 6 GHz band. The AP MLD 902's MLD MAC Address is MAC_MLD_A, while the non-AP MLD 904's MLD MAC Address is MAC_MLD_N1 and is assigned an AID AID1.

In this embodiment, the multi-link WLAN sensing procedure 900 includes a sensing session 918, in which the three links are associated with a single multi-link sensing session between the first MLD 902 and the second MLD 904 and the first MLD 902 is the sensing Initiator MLD while the second MLD 904 is the sensing responder MLD. The sensing session is identified with the MLD MAC address of the peer MLD and/or AID, e.g., AP MLD 902 identifies the sensing session setup 918 as <MAC_MLD_N1, AID1> while the non-AP MLD 904 identifies the sensing setup 918 as <MAC_MLD_A1>.

The multi-link WLAN sensing procedure 900 further includes a sensing measurement setup 920, in which a sensing measurement setup for the three links, i.e. Links 1, 2, 3, is performed over one link, i.e. Link 1. In this embodiment, different STAs affiliated with the same MLD are assigned different sensing roles (sensing receiver or sensing transmitter) during the sensing measurement setup 920. This sensing measurement setup is assigned with a measurement setup ID1 and is identified by the tuple <MAC_MLD_A1, ID1>.

The multi-link WLAN sensing procedure 900 further includes sensing measurement instances 922 on Links 1, 2, 3. In the measurement instances, measurement setup operation attributes (e.g., sensing roles) are link specific. For example, in Link 1, the non-AP STA 914 is a sensing transmitter, while the AP 908 is a sensing receiver. In Links 2 and 3, the APs 906, 910 are sensing transmitters, while the non-AP STAs 912, 916 are sensing receivers. Sensing measurement instances for all 3 links are triggered simultaneously. The measurement setup operation attributes of a link is identified by the tuple <Sensing initiator MLD's MLD MAC Address, measurement setup ID, link id>.

The multi-link WLAN sensing procedure 900 further includes a sensing measurement reporting 924, in which sensing measurement reports of the three links are aggregated and transmitted on one link, i.e., Link 1.

The multi-link WLAN sensing procedure 900 further includes a sensing measurement instance 926 on Link 3 and a sensing measurement reporting 928 on Link 1 for Link 3. The sensing measurement reports of one link, Link 3, is transmitted on another link, i.e. Link 1.

The multi-link WLAN sensing procedure 900 further includes a sensing measurement setup 930 on Link 1 for Link 2 and a sensing measurement instance 932 on Link 2. The sensing measurement setup for a link, i.e. Link 2, is performed over another link, i.e. Link 1. This sensing measurement setup is assigned with a measurement setup ID2.

The multi-link WLAN sensing procedure 900 further includes a sensing measurement reporting 934, in which sensing measurement reports of a link, i.e. Link 2, are aggregated and transmitted on another link, i.e. Link 1.

The multi-link WLAN sensing procedure 900 further includes a sensing measurement setup termination 936 for measurement setup ID1 for multiple links, i.e. Links 1, 2, 3, performed over any one link, e.g. Link 1; and a sensing measurement setup termination 938 for measurement setup ID2 for Link 2 performed over another link, i.e. Link 1.

The multi-link WLAN sensing procedure 900 further includes a sensing session termination 940 for multiple links, i.e. Links 1, 2, 3, performed over any one link, e.g. Link 1

In this embodiment 900, Link 1 is designated as the link where all sensing related management frame exchanges (except frames/PPDUs related to the actual channel measurements (e.g., NDPA frame, NDP, TF etc.)) take place. This can advantageously allow the non-AP STAs 912, 914, 916 to save power by operating on power save modes on Link 2 and Link 3, and only wake up on Link 2 and Link 3 for measurement instances (e.g., by negotiating Target Wake Time (TWT) Service Periods (SP) that overlap with measurement instance periods with the AP MLD 902.

FIG. 10 illustrates a block diagram depicting an exemplary signaling process 1000 between a first MLD 1002 and a second MLD 1004 during a multi-link WLAN sensing procedure.

In the exemplary signaling process 1000, the first MLD 1002 is an AP MLD and the second MLD 1004 is a non-AP MLD. There are three links between the two MLDs, i.e., Link 1 in the 5 GHz band, Link 2 in the 2.4 GHz band, and Link 3 in the 6 GHz band.

The signaling process 1000 comprises a multi-link sensing discovery 1006, a multi-link sensing session setup 1010, a multi-link sensing measurement setup 1012, a multi-link sensing measurement instances 1014, and a termination 1016.

In this exemplary signaling process 1000, the first MLD 1002 and the second MLD 1004 have been associated by performing authentication and multi-link setup (association) 1008 prior to the multi-link sensing session setup 1010. An alternative exemplary signaling process 2800 is depicted in FIG. 28, in which the first MLD 1002 and the second MLD 1004 are not associated prior to the multi-link sensing session setup 1010. Details of the alternative exemplary signaling process 2800 are illustrated in FIG. 28 and described in the corresponding paragraphs.

In the multi-link sensing discovery 1006, the first MLD 1002 discovers multi-link sensing capability as well as sensing capabilities of all links of the second MLD 1004 by passively receiving Beacon frames from the second MLD 1004, or by exchanging Probe Request frame and Probe Response frame with the second MLD 1004 in any one of the links, e.g., Link 1.

In the authentication and multi-link setup (association) 1008, the first MLD 1002 indicates its multi-link sensing capability as well as sensing capability of all links by exchanging Association Request and Association Response with second MLD 1004 in Link 1. Immediately afterwards, the two MLDs negotiate Security Association, e.g., by performing the robust security network association (RSNA) 4-way handshake and generate the applicable secret keys, e.g., pairwise transient key (PTK).

In the multi-link sensing session setup 1010, the first MLD 1002 and the second MLD 1004 negotiates multi-link sensing session setup for all three links, by exchanging Protected Sensing Session Setup Request and Protected Sensing Session Setup Response in Link 1.

In the multi-link sensing measurement setup 1012, the first MLD 1002 and the second MLD 1004 negotiates multi-link sensing measurement setup for all three links, by exchanging Protected Sensing Session Setup Request and Protected Sensing Session Setup Response in Link 1.

In the multi-link sensing measurement instances 1014, the first MLD 1002 performs multi-link sensing measurement for the measurement PPDUs received from the second MLD 1004 on all three links and sends an aggregated measurement report of the three links on Link 1.

In the termination 1016, the first MLD 1002 terminates sensing session setup and sensing measurement setup on Link 1 for the three links.

FIG. 11 illustrates a flowchart illustrating another embodiment 1100 of the method 400. In this embodiment, the method 400 is implemented as a multi-link WLAN sensing procedure 1100 between a first MLD 1102, a second MLD 1104 and another second MLD 1106.

The embodiment 1100 is similar to the embodiment 900, except that the multi-link WLAN sensing procedure 1100 includes one more second MLD 1106.

In this embodiment, the first MLD 1102 is AP MLD that comprises three APs 1108, 1110, 1112. The second MLD 1104 is a non-AP MLD that comprises three non-AP STAs 1114, 1116, 1118. The additional second MLD 1106 is a non-AP MLD that comprises two non-AP STAs 1120, 1122. There are three links between the first MLD 1102 and the second MLD 1104, i.e., Link 1 between AP 1110 and non-AP STA 1116 in the 5 GHz band, Link 2 between AP 1108 and non-AP STA 1114 in the 2.4 GHz band, and Link 3 between AP 1112 and non-AP STA 1118 in the 6 GHz band. There are two links between the first MLD 1102 and the additional second MLD 1106, i.e. Link 1 between AP 1110 and non-AP STA 1120 in the 5 GHz band, and Link 3 between AP 1112 and non-AP STA 1122 in the 6 GHz band.

In this embodiment, the multi-link WLAN sensing procedure 1100 includes a sensing session 1124, in which the first MLD 1102 acts as the sensing initiator MLD and the second MLD 1104 is configured as the sensing responder MLD and three links are associated with a single multi-link sensing session between the first MLD 1102 and the second MLD 1104.

The multi-link WLAN sensing procedure 1100 further includes a sensing measurement setup 826, in which a sensing measurement setup for the three links between the first MLD 1102 and the second MLD 1104, i.e. Links 1, 2, 3, is performed over one link, i.e. Link 1. This sensing measurement setup is assigned with a measurement setup ID1. In this embodiment, the measurement setup operation attributes (e.g., sensing roles) are link specific and different STAs affiliated with the same sensing responder MLD are assigned different sensing roles (sensing receiver or sensing transmitter) during the sensing measurement setup 920. For example, in Link 1, the non-AP STA 1116 is a sensing transmitter, while the AP 1110 is a sensing receiver. In Links 2 and 3, the APs 1108, 1112 are sensing transmitters, while the non-AP STAs 1114, 1118 are sensing receivers.

The multi-link WLAN sensing procedure 1100 further includes sensing measurement instances 1128 on Links 1, 2, 3 between the first MLD 1102 and the second MLD 1104. In the measurement instances 1128, sensing measurement instances for all 3 links are triggered simultaneously. The measurement instances are assigned a same measurement instance ID1 on all the links.

The multi-link WLAN sensing procedure 1100 further includes a sensing measurement reporting 1130, in which sensing measurement reports of the three links are aggregated and transmitted on one link, e.g, on Link 1. In the sensing measurement reporting 1130, a same measurement instance ID1 is used to identify measurement instances on all links.

The multi-link WLAN sensing procedure 1100 further includes a sensing session 1132, in which two links, Link 1 and Link 3, are associated with a single multi-link sensing session between the first MLD 1102 and the additional second MLD 1106. Here, the first MLD 1102 acts as the sensing initiator MLD and the additional second MLD 1106 is configured as the sensing responder MLD.

The multi-link WLAN sensing procedure 1100 further includes a sensing measurement setup 1134, in which a sensing measurement setup for the two links, Link 1 and Link 3, between the first MLD 1102 and the additional second MLD 1106 is performed over one link, i.e. Link 1. In this embodiment, the measurement setup operation attributes (e.g., sensing roles) are link specific, e.g., different STAs affiliated with the same MLD may be assigned same or different sensing roles (sensing receiver or sensing transmitter) during the sensing measurement setup 920. For example, in Link 1 between the first MLD 1102 and the second MLD 1104, the non-AP STA 1116 is a sensing transmitter, while the AP 1110 is a sensing receiver. In Link 3 between the first MLD 1102 and the second MLD 1104, the AP 1112 is a sensing transmitter, while the non-AP STA 1118 is a sensing receiver. In Link 1 between the first MLD 1102 and the additional second MLD 1106, the AP 1110 is a sensing receiver and the non-AP STA 1120 is a sensing transmitter. In Link 3 the first MLD 1102 and the additional second MLD 1106, the AP 1112 is a sensing transmitter, while the non-AP STA 1122 is a sensing receiver. This sensing measurement setup between the first MLD 1102 and the additional second MLD 1106 is also assigned with a measurement setup ID1 and hence both non-AP MLDs 1104 and 1106 are part of the same multi-link measurement setup (ID1).

The multi-link WLAN sensing procedure 1100 further includes sensing measurement instances 1136 on Links 1, 3 between the first MLD 1102 and the second MLD 1104 and Links 1, 3 between the first MLD 1102 and the additional second MLD 1106. In the measurement instances 1136, the sensing measurement instances for both links are triggered simultaneously. The measurement instances are assigned a same measurement instance ID2 on all the links.

The multi-link WLAN sensing procedure 1100 further includes a sensing measurement reporting 1138, in which sensing measurement reports of Links 1, 3 between the first MLD 1102 and the second MLD 1104 are aggregated and transmitted on one link, i.e. Link 1 between the first MLD 1102 and the second MLD 1104. In the sensing measurement reporting 1130, a same measurement instance ID2 is used to identify measurement instances on both links.

The multi-link WLAN sensing procedure 1100 further includes a sensing measurement reporting 1140, in which sensing measurement reports of Links 1, 3 between the first MLD 1102 and the additional second MLD 1106 are aggregated and transmitted on one link, i.e. Link 1 between the first MLD 1102 and the additional second MLD 1106. In the sensing measurement reporting 1140, a same measurement instance ID2 is used to identify measurement instances on both links but the link ids of the links are used to differentiate the reports for different links.

The multi-link WLAN sensing procedure 1100 further includes a sensing measurement instance 1142 on Link 3 between the first MLD 1102 and the additional second MLD 1106 and a sensing measurement reporting 1144 on Link 1 between the first MLD 1102 and the additional second MLD 1106 for Link 3. The measurement instance 1142 is assigned a measurement instance ID3 on Link 3. In this manner, the sensing measurement reports of one link, Link 3 between the first MLD 1102 and the additional second MLD 1106, is transmitted on another link, i.e. Link 1 between the first MLD 1102 and the additional second MLD 1106. In the sensing measurement reporting 1144, the measurement instance ID3 and the link id of Link 3 is used to identify measurement instance on Link 3.

Similarly, the multi-link WLAN sensing procedure 1100 further includes a sensing measurement setup termination 1146 for measurement setup ID1 for multiple links, i.e. Links 1, 2, 3 between the first MLD 1102 and the second MLD 1104, performed over any one link, e.g. Link 1; and a sensing session termination 1148 for multiple links, i.e. Links 1, 2, 3 between the first MLD 1102 and the second MLD 1104, performed over any one link, e.g. Link 1.

Similarly, the multi-link WLAN sensing procedure 1100 further includes a sensing measurement setup termination 1150 for measurement setup ID1 for multiple links, i.e. Links 1, 2, 3 between the first MLD 1102 and the additional second MLD 1106, performed over any one link, e.g. Link 1; and a sensing session termination 1152 for Links 1, 3 between the first MLD 1102 and the additional second MLD 1106, performed over any one link, e.g. Link 1.

As mentioned above, the technical solutions provided in the present disclosure are not only applicable to multi-link WLAN sensing procedures (e.g., as depicted in FIG. 11), but also applicable to other WLAN applications such as multi-link WLAN ranging procedures. An alternative embodiment 3100 of the method 400 is depicted in FIG. 31. In the alternative embodiment 3100, the method 400 is implemented as a multi-link WLAN ranging procedure 3100 between a first MLD 3102, a second MLD 3104 and another second MLD 3106. Details of the multi-link WLAN ranging procedure 3100 are illustrated in FIG. 31 and described in the corresponding paragraphs.

FIG. 12 illustrates an embodiment of a Basic Multi-Link element 1200 that can be used by the first MLD 1002 and/or the second MLD 1004 to indicate multi-link sensing capability of the first MLD 1002 and/or the second MLD 1004 in a multi-link sensing discovery phase 1006 or the multi-link setup phase 1008 of the multi-link WLAN sensing procedure 1000 as depicted in FIG. 10. The Basic Multi-Link element 1200 can be used in applicable frames such as Beacon, Probe Request/Response, Association Request/Response, etc.

In the embodiment, the Basic Multi-Link element 1200 includes a field 902 of multi-link sensing which indicates support for multi-link sensing, and a field 904 of sensing capabilities element which indicates sensing capabilities of the affiliated STA operating on the nth non-anchor link. This sensing capabilities element is present in field 904 if the WLAN Sensing field of the Extended Capabilities element corresponding to the link is set to 1.

As depicted in FIG. 10, an MLD advertises its multi-link sensing capability as well as the sensing capabilities of the affiliated STAs operating on its non-anchor links using Basic Multi-link element in applicable frames such as Beacon, Probe Request/Response, Association Request/Response etc. The sensing capabilities of the affiliated STA operating on the anchor link (e.g., Link 1) is advertised in the sensing capabilities element 904 carried in the frame body.

In some embodiments, anchor link refers to a link on which the frame carrying the Multi-link element is transmitted. Non-anchor link refers to setup links other than the anchor link. For non-transmitted BSSID case, the anchor link refers to the link on which the AP transmitting the Non-transmitted BSSID element that carries the Multi-link element operates.

Alternatively, some or all link specific sensing capabilities may be carried in the Extended Capabilities element in the Basic Multi-Link element 1200. The Sensing Capabilities of the AP affiliated with an AM MLD may also be advertised using a Reduced Neighbour Report element in Beacon frames transmitted by the APs.

FIG. 13A illustrates an embodiment of a Protected Sensing Session Setup Request frame 1300. FIG. 13B illustrates an embodiment of a Protected Sensing Session Setup Response frame 1350. In an embodiment, the Protected Sensing Session Setup Request frame 1300 and the Protected Sensing Session Setup Response frame 1350 are exchanged between the first MLD 1002 and the second MLD 1004 in a multi-link sensing setup 1010 of the multi-link WLAN sensing procedure 1000 as depicted in FIG. 10. The frames may be exchanged on any one of the enabled links between the two MLDs. Although not shown in FIG. 13A, the Protected Sensing Session Setup Request frame may also carry additional field, e.g. a Validation Info field, for example to carry some form of validation that the STA or the MLD requesting the Sensing Session Setup is authorized for sensing operations. The proof may be a secret password either in plaintext or in encrypted form (e.g. hashed with a common secret key e.g., PTK). Alternatively, the validation may be performed by the STA or MLD that receives the Sensing Session Setup Request frame out of band, e.g., by checking with a database of authorized devices on a connected server etc.

In the Protected Sensing Session Setup Response frame 1350, a field of status code indicates whether the session setup request is successful or not. If a Validation Info field is included in the Session Setup Request frame, additional checking of the validation information (e.g., password) is also performed to ensure that the STA/MLD requesting the Sensing Session setup is authorized for the sensing session, the status code indicating success if the validation check is successful and indicating an appropriate failure code (e.g. VALIDATION_FAILED etc.) if the validation check is unsuccessful. Also, although not shown in the figure, the frame, when sent by a non-AP MLD, the request frame may also carry an indication whether the Non-AP MLD intends to act as a Sensing Initiator MLD or it requests the AP MLD to act as the Sensing Initiator MLD.

FIG. 13C illustrates an embodiment of a Link Info Element, which is carried in the frame body of the Protected Sensing Session Setup Request frame 1300 and/or the Protected Sensing Session Setup Response frame 1350. In the Link Info Element, there is a field of Link ID Bitmap. When each bit is set to 1 in the Link ID Bitmap field, it indicates that the corresponding link is included in the multi-link sensing session setup.

FIG. 13D illustrates an embodiment of a Sensing Session Parameters, which is a segment of frame body of the Protected Sensing Session Setup Request frame 1300 and/or the Protected Sensing Session Setup Response frame 1350.

The Sensing Session Parameters field carries parameters that are applicable for the entire duration of the multi-link sensing session setup:
Session Timeout: If there are no sensing related frame exchanges during this time, the sensing session setup is automatically terminated.
Sensing NDP Format: The NDP format (HE, EHT, Ranging etc.) to be used for channel measurements for sensing for that sensing session.
Sensing related capabilities may also be exchanged during the sensing session setup instead/in-addition of during Multi-link setup.

FIG. 14A illustrates an embodiment of a Protected Sensing Measurement Setup Request frame 1400. FIG. 14B illustrates an embodiment of a Protected Sensing Measurement Setup Response frame 1450. In an embodiment, the Protected Sensing Measurement Setup Request frame 1400 and the Protected Sensing Measurement Setup Response frame 1450 are exchanged between the first MLD 1002 and the second MLD 1004 in a multi-link sensing measurement setup 1012 of the multi-link WLAN sensing procedure 1000 as depicted in FIG. 10. The frames may be exchanged on any one of the enabled links between the two MLDs. In the Protected Sensing Measurement Setup Response frame 1450, the status code indicates whether the measurement setup request is successful or not.

In the Protected Sensing Measurement Setup Request frame 1400 and the Protected Sensing Measurement Setup Response frame 1450:
Measurement Setup ID field carries the ID of the measurement setup being negotiated between the two MLDs and is same for all links. As described above, operation attributes of a link are identified by a tuple <Sensing Initiator's MLD MAC Address, Measurement Setup ID, Link Id>. One or more Measurement Setup IDs may be uniquely mapped to a sensing application running on the MLD.
The Sensing Measurement Parameters Element carried in the frame body carries parameters that are applicable to the anchor link. If the anchor link is not included in the sensing measurement setup, it is omitted.
In addition, the Sensing Multi-Link Element carries parameters that are applicable to the non-anchor links that are part of the multi-link sensing measurement setup. Inclusion of the Sensing Measurement Parameters Element (either in the frame body, or within a Sensing Multi-Link element) indicates if a link is included in the multi-link sensing measurement setup. Such links that are included in the multi-link sensing measurement setup may be called Sensing links.

FIG. 14C illustrates an embodiment of a Sensing Measurement Parameters Element 1402, which is included in the frame body of the Protected Sensing Measurement Setup Request frame 1400 and/or the Protected Sensing Measurement Setup Response frame 1450.

In the Sensing Measurement Parameters Element 1402, a field of Sensing Measurement Parameters carries parameters related to the sensing measurement setup: e.g., roles of the STA affiliated with the Sensing Responder MLD operating on the link, whether the Sensing Measurement Report is requested, and if yes, the Type of the Measurement Report (CSI, Partial_CSI) etc., Sampling Rate i.e., the rate at which the Sensing Measurement PPDUs are transmitted.

FIG. 14D illustrates an embodiment of a Sensing Multi-Link Element 1404, which is carried in the frame body of the Protected Sensing Measurement Setup Request frame 1400 and/or the Protected Sensing Measurement Setup Response frame 1450. The Sensing Multi-Link Element 1404 is a new variant of Multi-Link element, which carries the parameters that are applicable to the non-anchor links that are part of the Multi-Link sensing measurement setup.

As described above, one of the links may be designated as a Reporting Link i.e., a default link that is used for transmitting the sensing measurement reports generated by all the affiliated STAs that participate in the Multi-Link WLAN Sensing procedure. The Reporting Link may or may not be included in the list of Sensing links during the Multi-link Measurement Setup and may not be involved in the actual sensing channel measurements.

As shown, the Sensing Multi-Link Element 1404 includes a field that indicates the type of the multi-link element. The Sensing Multi-Link Element 1404 includes a field of common sensing measurement parameters, which includes a field of Link ID of Reporting Link, which carries parameters related to the multi-link sensing measurement setup that are common to all participating links, which may indicate the Link ID of the default link that is used for transmitting the sensing measurement report(s). The Sensing Multi-Link Element 1404 also includes a field of Link Info, which carries information related to the non-anchor link that are part of the multi-link sensing measurement setup. A Sensing Measurement Parameters element included in the STA Profile field of a Per-STA Profile subelement for a link n, carries the measurement parameters applicable to the link n. Although not shown in FIG. 14A, when the first Protected Sensing Measurement Setup frame exchange is also used to establish Sensing Sessions between two MLDs, the Protected Sensing Measurement Setup Request frame may also carry additional field, e.g. a Validation Info field, for example to carry some form of validation that the STA or the MLD requesting the Sensing Session Setup is authorized for sensing operations. The proof may be a secret password either in plaintext or in encrypted form (e.g. hashed with a common secret key e.g., PTK). Alternatively, the validation may be performed by the STA or MLD that receives the Sensing Session Setup Request frame out of band, e.g., by checking with a database of authorized devices on a connected server etc. If a Validation Info field is included in the Protected Sensing Measurement Setup Request frame, additional checking of the validation information (e.g., password) is also performed to ensure that the STA/MLD requesting the Sensing Session/Measurement setup is authorized for the sensing operation, the status code indicating success if the validation check is successful and indicating an appropriate failure code (e.g. VALIDATION_FAILED etc.) if the validation check is unsuccessful. Also, although not shown in the figure, the frame, when sent by a non-AP MLD, the request frame may also carry an indication whether the Non-AP MLD intends to act as a Sensing Initiator MLD or it requests the AP MLD to act as the Sensing Initiator MLD.

FIG. 15 illustrates embodiments of sensing roles, e.g., sensing initiator MLD and sensing responder MLD roles assigned to MLDs and a sensing receiver or a sensing transmitter, that can be assigned to respective stations (STAs) affiliated with the first MLD 1002 and/or the second MLD 1004 in a multi-link sensing measurement setup 1012 of the multi-link WLAN sensing procedure 1000 as depicted in FIG. 10. It shows that different STAs affiliated with the same MLD 1002 or 1004 can be assigned with same or different sensing roles during the sensing measurement setup 1012. In the figure, ST stands for sensing transmitter while SR stands for sensing receiver.

In some embodiments, even for a same sensing session, different links may have different role setups, e.g., STA1 performs measurements for Link 1 while AP2 performs measurements for Link 2.

In some embodiments, affiliated STAs operating on the reporting link may not be assigned any sensing roles. That is, they may be neither a sensing transmitter nor a sensing receiver.

In some embodiments, sensing measurement reports, i.e., feedbacks, are sent on a link that is different from the link used for the channel measurement (feedback for Link 1 is sent on Link 2).

FIG. 16 illustrates an embodiment of a Sensing Null Data Packet Announcement (NDPA) frame 1600. FIG. 17 illustrates an embodiment of a Sensing Report Trigger frame 1700. In an embodiment, the NDPA frame 1600 and the Sensing Report Trigger frame 1700 are exchanged between the first MLD 1002 and the second MLD 1004 in a multi-link sensing measurement instance 1014 of the multi-link WLAN sensing procedure 1000 as depicted in FIG. 10.

In the NDPA frame 1600, there is a field of Delayed Reporting which indicates whether the transmission of the measurement report corresponding to the I2R NDP can be delayed, and a field of Reporting Link ID which identifies the link in which the measurement report corresponding to the I2R NDP is to be sent on and overrides the default reporting link setup during measurement setup.

In the Sensing Report Trigger frame 1700, there is a field of Measurement Setup and Instance ID which identifies the measurement setup ID and the corresponding instance IDs for which measurement reports are solicited, and a Report Link ID Bitmap which identifies the links for which the measurement reports are solicited.

FIG. 18 illustrates a flowchart illustrating an embodiment 1800 of the multi-link sensing measurement instance 1014. In this embodiment, the multi-link sensing measurement instance 1014 is a Trigger Based (TB) multi-link sensing measurement instance 1800 between a first MLD 1802 and a second MLD 1804.

The TB multi-link sensing measurement instance is a trigger-based variant of the multi-link sensing measurement instance 1014. It is applicable to scenarios where the first MLD 1802 (i.e., the sensing initiator MLD) is an AP MLD, and one or more second MLDs 1804 (i.e. the sensing responder MLDs) are non-AP MLDs. For the sake of simplicity, only a single non-AP MLD 1804 is shown in FIG. 18, but it is noted that more than one Non-AP MLD would be involved in a TB based Sensing measurement instance.

The TB multi-link sensing measurement instance includes one or more of the following phases: Polling phase, NDPA sounding phase, Trigger frame (TF) sounding phase, and reporting phase.

As shown in FIG. 18, each Polling phase, TF sounding phase, and reporting face is initiated by a Trigger frame (TF) followed by a Clear to Send (CTS) frame, a Responder to Initiator (R2I) NDP, or an aggregated Sensing Measurement Report frame for sensing measurement reportings for Links 1 and 2, respectively. The AP MLD 1802 initiates the Polling Phases on both links at the same time, but the actual start time may vary between the links due to channel access delays etc. Each NDPA sounding phase is initiated by a Sensing NDPA frame followed by a Initiator to Responder (I2R) NDP.

In the TB Multi-Link sensing measurement instances, a same Measurement Instance ID is used on all links for sensing measurement instances that are triggered at the same time.

In the TB Multi-Link sensing measurement instances, the Reporting Link ID field in the Sensing NDPA can be set to a reserved value (e.g., 0 or 15) that is not assigned to any of the AP MLD 1802's links, to signal that no link is recommended for sensing measurement reporting and the responder MLD(s) 1804 are to wait for a Trigger frame from any of the APs affiliated with the AP MLD 1802 to allocate RU to transmit the sensing measurement report(s). If the Reporting Link ID field in the Sensing NDPA is set to one of the setup links, the responder MLD(s) 1804 are to wait for a Trigger frame from the APs affiliated with the AP MLD 1802 that operates on the specified link.

In the Sensing NDPA frames, the Delayed Reporting field is set to 1 and the Reporting Link ID is set to 1 (Link 1).

In this embodiment, the Reporting phase in Link 2 is skipped while the Reporting phase in Link 1 starts after all the preceding phases of the sensing measurement instances (for a particular Sensing Measurement Instance ID) on both links have ended. The Sensing Report

Trigger frame (TF) transmitted by AP 2 (on Link 1) allocates RU to STA2 such that the RU is big enough to accommodate the aggregated Sensing Measurement Report frame that carries the sensing measurement reports (i.e., feedbacks for the channel measurement performed for the I2R NDP) for both Link 1 and Link 2.

FIG. 19 illustrates a flowchart illustrating another embodiment 1900 of the multi-link sensing measurement instance 1014. In this embodiment, the multi-link sensing measurement instance 1014 is a non-Trigger Based (non-TB) multi-link sensing measurement instance 1900 between a first MLD 1902 and a second MLD 1904.

Non-TB multi-link sensing measurement instance is a non-trigger-based variant of the multi-link sensing measurement instance 1014. It is applicable to scenarios where the first MLD 1902 (i.e., the sensing initiator MLD) is a non-AP MLD, and the second MLD 1904 (i.e., the sensing responder MLD) is an AP MLD. Whenever the medium is available, a non-AP STA affiliated with the non-AP MLD may initiate a non-TB sensing measurement instance.

As shown in FIG. 19, each non-TB sensing measurement instance is initiated by a Non-AP MLD transmitting a Sensing NDPA frame followed by a I2R NDP and the AP responding by transmitting a R2I NDP. The non-AP MLD 1902 initiates non-TB sensing measurement instances on both links at the same time, but the actual start time may vary between the links due to channel access delays etc.

The embodiment 1900 includes two sensing measurement instances, each taken place in a sensing measurement Setup 1 or Step 2. Setup 1 is for Multi-Link Sensing and involves channel measurements on both links. In Setup 2, channel measurements are only performed on Link 2 but the sensing measurement report may be transmitted on a different link (Link 1).

In Link 2, the Delayed Reporting field is set to 1 and the Reporting Link ID is set to 1 (Link 1) in the Sensing NDPA frames. Sensing measurement reports are omitted on Link 2.

In Link 1, the Delayed Reporting field is set to 0 and the Reporting Link ID is set to 1 (Link 1) in the sensing NDPA frames. Thus, an aggregated sensing measurement reporting for the sensing measurement Setup 1 on Links 1 and 2 is not delayed, which immediately follows the R2I NDP after a short interframe space (SIFS) on Link 1.

In the non-TB Multi-Link sensing instances, if the Delayed Reporting field in the Sensing NDPA is set to 1 and the Reporting Link ID field in the Sensing NDPA is set to one of the setup link, the sensing responder MLD shall not transmit the sensing measurement report SIFS after the R2I NDP but instead shall transmit the sensing measurement report in a delayed manner in the specified link, i.e. either aggregated with another sensing measurement report (e.g., SIFS after the R2I NDP) or in a separate TXOP.

FIG. 20 illustrates an embodiment of a Protected Sensing Measurement Report frame 2000. In an embodiment, the Protected Sensing Measurement Report frame 2000 is transmitted from a STA affiliated with a sensing responder MLD (i.e. a second MLD) to a STA affiliated with an sensing initiator MLD (i.e. a first MLD) to provide results of channel measurements obtained from one ore more sensing measurement instances of the one ore more corresponding links. The transmission of the Protected Sensing Measurement Report frame 2000 is done prior to a termination session 1016 of the multi-link WLAN sensing procedure 1000 as depicted in FIG. 10.

Multiple sensing measurement reports, for same or different links may be carried in a single frame. The link corresponding to the Sensing Measurement Report is indicated in the Measurement Link ID field of the frame 2000.

In the embodiment 2000, the Protected Sensing Measurement Report frame 2000 includes a field of Sensing Measurement Report List to carry one or more Sensing Measurement Reports. The field of Sensing Measurement Report List includes a field of Sensing Measurement Report, in which each Sensing Measurement Report carries the channel measurement feedback (in the Sensing Measurement Feedback field) for a particular combination of Measurement Setup ID, Measurement Instance ID of a link identified by the Link ID field. Each Sensing Measurement Report comprises a field of Sensing Measurement Time, which indicates the time at which the sensing measurement was performed (i.e., time at which the Sensing NDP used for channel measurement was received), e.g., 4 LSBs of the devices Time Synchronization Function (TSF); a Measurement Link ID which Identifies the link in which the channel measurement was performed; and a Sensing Measurement Feedback which carries the channel measurement results of the sensing measurement (e.g., CSI, Partial_CSI etc.), etc. performed on the indicated link. The rest of the fields in the Protected Sensing Measurement Report frame 2000 are self-explanatory in FIG. 20 and are not described in detail herein for the sake of simplicity.

The sensing initiator MLD, upon receiving a Protected Sensing Measurement Report frame, uses the Link ID field to separate the sensing measurement reports for different links and passes up to the sensing application (mapped to the Measurement Setup ID) for application specific processing and analyses

FIG. 21 illustrates an embodiment of a Protected Sensing Session Setup Termination frame 2100. FIG. 22 illustrates an embodiment of a Protected Sensing Measurement Setup Termination frame 2200.

In an embodiment, the termination session 1016 of the multi-link WLAN sensing procedure 1000 as depicted in FIG. 10 comprises a multi-link sensing measurement termination, followed by a multi-link sensing session termination. In the multi-link sensing measurement termination, the Protected Sensing Measurement Setup Termination frame 2200 is exchanged between the first MLD 1002 and the second MLD 1004 to terminate one or more multi-link sensing measurement setup between the first MLD 1002 and the second MLD 1004. The Measurement Setup ID Information field 2210 carries the measurement setup IDs of the one or more multi-link sensing measurement setup to be terminated. Although not shown in FIG. 22, the Protected Sensing Measurement Setup Termination frame 2200 may also carry a control field, where a “Terminate all” bit may be set to 1 to indicate that all multi-link sensing measurement setups between the first MLD 1002 and the second MLD 1004 are to be terminated. Similarly, a “Terminate Sensing Session” bit may be set to 1 to indicate that the multi-link Sensing session between the two MLDs are to be terminated as well. Alternatively, if the “Terminate all” bit is set to 1, it can also signal the termination of sensing session between the two STAs/MLDs on all links as well. In the multi-link sensing session termination, the Protected Sensing Session Setup Termination frame 2100 is exchanged between the first MLD 1002 and the second MLD 1004 to terminate the multi-link sensing session setup between the first MLD 1002 and the second MLD 1004.

FIG. 23 illustrates a flowchart illustrating an embodiment 2300 showing generation and transmission of MAC Layer Management Entity (MLME) primitives taken place at a station management entity (SME) 2306 and a MLD MLME 2308 of a first MLD 2302 and at a station management entity (SME) 2312 and a MLD MLME 2310 of a second MLD 2304 during a non-Trigger Based (non-TB) multi-link sensing procedure 2314. The respective MLME primitives instruct the first MLD 2302 and the second MLD 2304 to perform the non-Trigger Based (non-TB) multi-link sensing procedure 2314 in accordance with embodiments of the present disclosure, which comprises a multi-link sensing session setup 2316, a multi-link sensing measurement setup 2318, a multi-link sensing measurement instance 2320, a multi-link sensing measurement setup termination 2322, and a sensing session setup termination 2324. In this embodiment, the first MLD 2302 is a non-AP MLD with two affiliated non-AP STAs. The second MLD 2304 is an AP MLD with two affiliated APs. There are two links between the first MLD 2302 and the second MLD 2304, i.e. Link 1 in the 5 GHz band between STA1 and AP1, and Link 2 in the 6 GHz band between STA2 and AP2.

In the multi-link sensing measurement instance 2320, a MLME-SENSNTBMSMTRQ.request (link 2) is generated by the SME 2306 of the first MLD 2302 to request Measurement Instance on Link 2. It is noted that Measurement Instances can be requested on multiple links by indicating the link IDs. In response to this request, a Sensing Measurement instance is performed between the first MLD 2302 and the second MLD 2304, which is followed by a MLME-SENSNTBREPORT.indication (link 2) generated by the MLD MLME 2310 of the second MLD 2304, which Indicates that measurement report is received for link 2. Such report is transmitted back to the first MLD 2302 through a Sensing Measurement Report frame. Upon receipt on the first MLD 2302, the MLD MLME 2308 of the first MLD 2302 generates a MLME-SENSNTBMSMTRQ.confirm (link 2) to Indicate that the measurement report is received for Link 2 (although the report frame itself is received on Link 1).

As shown in FIG. 23, the MLME primitives further include at least the following primitives:
MLME-SENSSSNSETUP.request: This primitive is generated by the SME to request that a Sensing Session Setup Request frame be sent to a peer MLD to setup sensing session. On receipt of this primitive, the MLD MLME constructs a Sensing Session Setup Request frame and causes it to be transmitted to the peer MLD MAC address on one of the setup links.
MLME-SENSSSNSETUP.indication: This primitive is generated by the MLD MLME when a Sensing Session Setup Request frame is received on any one of the setup links. On receipt of this primitive, the SME should either accept or reject the sensing session setup request.
MLME-SENSSSNSETUP.response: This primitive is generated by the SME to request that a Sensing Session Setup Response frame be sent to a peer MLD to either accept or reject a sensing session setup request.
MLME-SENSSSNSETUP.confirm: This primitive is generated by the MLD MLME when the STA receives a Sensing Session Setup Response frame.
MLME-SENSSSNTERMINATION.request: This primitive is generated by the SME to request that a Sensing Session Setup Termination frame be sent to a peer MLD to terminate a sensing session setup. On receipt of this primitive, the MLD MLME constructs a Sensing Session Setup Termination frame and causes it to be transmitted to the peer MLD MAC address.
MLME-SENSSSNTERMINATION.indication: This primitive is generated by the MLD MLME when a Sensing Session Setup Termination frame is received.
MLME-SENSSSNTERMINATION.confirm: This primitive is generated by the MLD MLME when an Ack frame corresponding to the Sensing Session Setup Termination frame is received from the peer MLD.

FIG. 24 illustrates a flowchart illustrating another embodiment 2400 showing generation and transmission of MAC Layer Management Entity (MLME) primitives taken place at a station management entity (SME) 2406 and a MLD MLME 2408 of a first MLD 2402 and at a station management entity (SME) 2412 and a MLD MLME 2410 of a second MLD 2404 during a Trigger Based (TB) multi-link sensing procedure 2414. The respective MLME primitives instruct the first MLD 2402 and the second MLD 2404 to perform the Trigger Based (TB) multi-link sensing procedure 2414 in accordance with embodiments of the present disclosure, which comprises a multi-link sensing session setup 2416, a multi-link sensing measurement setup 2418, a multi-link sensing measurement instance 2420, a multi-link sensing measurement setup termination 2422, and a sensing session setup termination 2424. In this embodiment, the first MLD 2402 is an AP MLD with two affiliated AP. The second MLD 2404 is a non-AP MLD with two affiliated non-AP STAs. There are two links between the first MLD 2402 and the second MLD 2404, i.e. Link 1 in the 5 GHz band between STA1 and AP1, and Link 2 in the 6 GHz band between STA2 and AP2.

In the embodiment 2400, the MLME primitives are similar to those in the embodiment 2300, except that the Sensing Measurement instances are triggered between the first MLD 2402 and the second MLD 2404 by the AP MLD (i.e., the first MLD 2402).

FIG. 25A depicts an exemplary multi-link WLAN sensing environment 2500 which comprises a first MLD 2502 and a second MLD 2504. In this embodiment, the first MLD 2502 is an AP MLD 2502 and the second MLD is a non-AP MLD 2504. The AP MLD 2502 and the non-AP MLD 2504 are configured to conduct a multi-link sensing procedure to detect features of an intended target 2506 through two WLAN sensing applications, e.g., Breathing estimation and Heart-rate estimation, in accordance with the embodiments of multi-link sensing procedure as described in the present disclosure.

FIG. 25B illustrates a flowchart illustrating an embodiment 2550 of a multi-link sensing procedure between the AP MLD 2502 and the non-AP MLD 2504 in the multi-link WLAN sensing system 2500.

In this embodiment, narrow band channels (e.g., 20 MHz in the 2.4 GHz band and 40 MHz in the 5 GHz band) are used for multi-Link sensing measurements while a wide band channel (e.g., 160 MHz in the 6 GHZ) is used for measurement reporting. This can advantageously help in sensing applications (e.g., Heart-rate detection) that require high sampling rate (i.e., rate at which sensing measurement results are collected, e.g., 100 Hz i.e., once every 10 ms) by allowing the sensing measurement reports, that typically occupy much higher air-time, to be transmitted on a link that provide a higher data rate.

In this embodiment, the multi-link WLAN sensing system 2500 supports two WLAN sensing applications (1. Breathing estimation, 2. Heart-rate estimation). Both applications use Model based algorithm (e.g., based on Fresnel zone) to detect and estimate human breathing rate and heartbeat rate. A Fresnel zone, is one of a series of ellipsoidal regions of space between and around a wireless transmitter and a wireless receiver. Fresnel reflection model in the indoor environments can be used to estimate human respiration rate using WLAN sensing systems.

In this embodiment, the AP MLD 2502 acts as the Sensing Initiator MLD while the associated non-AP MLD 2504 acts as the Sensing responder MLD. Two multi-link WLAN sensing applications (1. Breathing estimation, 2. Heart-rate estimation) runs on two laptops connected to the AP MLD 2502. The AP MLD 2502 sets up three sensing measurement setups (ID=1&2 for Breathing estimation, ID=3 for Heart-rate estimation) with the non-AP MLD 2504; setup ID 1 configuring Link 1 as Sensing link, while setup IDs 2 and 3 configuring Link 1 and Link 2 as Sensing links and all three configuring Link 3 as Reporting link. The breathing estimation applications includes two stages: 1) Human presence detection (setup ID=1) and 2) Breathing rate estimation (setup ID=2). Human presence detection is comparatively simpler and does not require high bandwidth sensing nor high sampling rate and is constantly running in the background (only a single instance is shown in FIG. 25B for simplicity). Once a human 2206 presence is detected, the breathing estimation application triggers the measurement instances for measurement setup ID=2 and measurement setup ID=3 on both links 1 and 2. Since Heart-rate estimation require a much higher sampling rate, the number of measurement instances corresponding to measurement setup ID=3 is much higher compared to setup IDs 1 and 2.

The sensing measurement reports are received on link 3 for all three measurement setups. This is configured by setting the Delayed Reporting field to 1 and the Reporting Link ID to 3 (link 3) in all Sensing NDPA frames.

The AP MLD 2502 upon receiving the sensing measurement reports on link 3, filters the reports based on the setup IDs and passes up to the respective sensing applications (e.g., all reports for setup IDs 1 and 2 to the breathing estimation application and all reports for setup ID 3 to the Heart-rate estimation application). The two applications may also communicate with each other, for e.g., the presence detection module in the breathing estimation application also triggers the Heart-rate estimation application upon detecting the presence of a human being 2206.

FIG. 26 illustrates a block diagram depicting an alternative exemplary signaling process 2600 between a first MLD 2602 and a second MLD 2604 during a multi-link WLAN sensing procedure. In this alternative exemplary signaling process 2600, only a multi-link sensing discovery 2602 and an authentication and multi-link setup 2608 (i.e. an association process to associate between the first MLD 2602 and the second MLD 2604) are depicted. In this embodiment, the multi-link sensing session set up 1010 as depicted in FIG. 10 is incorporated in the authentication and multi-link setup 2608. Specifically, a Sensing Session Setup Element is included in the Association request/response frames to negotiate sensing session setup during the Association process itself and thereby advantageously eliminating the need to perform additional frame exchanges for the sensing session setup.

For the sake of simplicity, the multi-link sensing measurement setup, multi-link sensing measurement instance, and termination processes are omitted in FIG. 26. It is understandable to those skilled in the art that the multi-link sensing measurement setup, multi-link sensing measurement instance, and termination processes can be same as those depicted in the other embodiments of the present disclosure.

FIG. 27 illustrates an embodiment of a Sensing Session Setup Element 2700, which can be included in Association request/response frames as described above, to achieve the multi-link sensing session setup in the authentication and multi-link setup 2608.

In the Sensing Session Setup Element 2700, there is a field of Action Type. When the Action Type is set as 0, it indicates the Element 2700 is for a Sensing Session Setup Request; whereas when the Action Type is set as 1, it indicates the Element 2700 is for a Sensing Session Setup Response. The Sensing Session Setup Element 2700 includes a field of Status Code, which when carried in an Association Response frame, indicates whether the session setup request is successful or not. The Sensing Session Setup Element 2700 also includes a field of Link ID Bitmap. When each bit is set to 1 in the Link ID Bitmap field, it indicates that the corresponding link is included in the multi-link sensing session setup. The rest fields in the Sensing Session Setup Element 2700 are self-explanatory in FIG. 27 and are not described in details herein for the sake of simplicity. Alternatively, it is also possible that, instead of the Association Request/Response frames, the Sensing Session Setup Element 2700 is carried in the first Sensing Measurement Setup Request/Response frames exchanged between two MLDs. Since the Sensing Measurement Setup frames are protected, this also allows the sensing session setup to be protected as well. Or, even without including the Sensing Session Setup Element, the first Sensing Measurement Setup Request/Response frames exchanged between two STAs or MLDs also starts a Sensing Session between the two STAs/MLDs.

FIG. 28 illustrates another embodiment of a Sensing Multi-Link Element 2800. The Sensing Multi-Link Element 2800 is included in the frame body of a Protected Sensing Measurement Setup Request frame as depicted in FIG. 14A and/or a Protected Sensing

Measurement Setup Response frame as depicted in FIG. 14B. The Sensing Multi-Link Element 2800 is similar to the Sensing Multi-Link Element 1404 depicted in FIG. 14D, except that the Sensing Multi-Link Element 2800 further includes a STA info field in each Per-STA profile field. The STA info includes a field of Measurement Instance ID Range, which indicates a range of measurement instance IDs assigned to a respective link. In this manner, different ranges of Measurement Instance IDs are assigned to different links such that the IDs for different links do not overlap with each other, thus ensuring that a link associated with a sensing measurement instance is identified by a corresponding Measurement Instance ID itself.

FIG. 29 illustrates a flowchart illustrating another embodiment of a multi-link WLAN sensing procedure 2900 between a first MLD 2902 and a second MLD 2904. In this embodiment, due to the Sensing Multi-Link Element 2800 comprised in Protected Sensing Measurement Setup Request/Response frames that are exchanged between the first MLD 2902 and the second MLD 2904 during a multi-link sensing measurement setup, different links associated with respective sensing measurements are identified by the corresponding Measurement Instance IDs. For example, during the first measurement setup (ID 1), measurement Instance IDs 0-75 are assigned to Link 1, measurement Instance IDs 76-150 are assigned to Link 2 and measurement Instance IDs 151-255 are assigned to Link 3. Subsequently Measurement Instance (ID 76) and Measurement Instance (ID 151) for the first measurement setup are performed on Link 2 and Link 3 respectively and the aggregated measurement report for both instances are transmitted on Link 1. The MLD receiving the aggregated measurement report can identify that Measurement Instance (ID 76) and Measurement Instance (ID 151) for the first measurement setup are performed on Link 2 and Link 3 respectively based on the instance IDs. Similarly during the second measurement setup (ID 2), measurement Instance IDs 0-255 are assigned to Link 1 since only Link 1 is used for the second measurement setup.

FIG. 30 illustrates another embodiment of a Protected Sensing Measurement Report frame 3000. The Protected Sensing Measurement Report frame 3000 is similar to the Protected Sensing Measurement Report frame 2000 depicted in FIG. 20, except that the Measurement Setup ID field and the Measurement Instance ID field in the Protected Sensing Measurement Report frame 3000 are now parallel to the sensing measurement control field in the sensing measurement report. Instead of a Measurement Link ID field used in the Protected Sensing Measurement Report frame 2000, the Protected Sensing Measurement Report frame 3000 uses the Measurement Instance ID field to identify the link in which the channel measurement corresponding to a Sensing Measurement Report was performed.

FIG. 31 illustrates a block diagram depicting an alternative exemplary signaling process 3100 between a first MLD 3102 and a second MLD 3104 during a multi-link WLAN sensing procedure according to an embodiment. In this alternative exemplary signaling process 3100, the first MLD 3102 and the second MLD 3104 are not yet associated prior to a multi-link sensing session setup 3108. As such, this embodiment 3100 of multi-link WLAN sensing procedure does not include the authentication and multi-link setup 1008 as depicted in FIG. 10. Instead, this embodiment 3100 of multi-link WLAN sensing procedure uses Preassociation (PA) Sensing Session Setup Request/Response frames exchanged between the first MLD 3102 and the second MLD 3104 in the multiple-link sensing session setup 3108, and includes an optional Preassociation Security Negotiation (PASN) 3109 process prior to the multi-link sensing measurement setup 3110. Alternatively, it is also possible that the Preassociation Security Negotiation (PASN) 3109 is performed prior to the Multi-Link Sensing Session Setup 3108, in which case, instead of using Public Action frames, Protected version of the frames (frames 1300 and 1350 in FIG. 13A and FIG. 13B) can be used for the Multi-Link Sensing Session Setup.

FIG. 32A illustrates an embodiment of a PA Sensing Session Setup Request frame 3202 and an embodiment of a PA Sensing Session Setup Response frame 3204. They are similar to the frames 1300 and 1350 in FIG. 13A and FIG. 13B, except that Public Action frame formats are used, and they also carry the Sensing Capabilities Element and the Basic Multi-Link Element. Alternatively, instead of using PA Sensing Session Setup Request/Response frames, an unassociated Non-AP MLD may send a MS Query frame carrying its sensing capabilities to the AP-MLD, indicating its interest to participate in Sensing operations, and the AP MLD, if it intends to participate in sensing operation with the Non-AP MLD, will initiate a Sensing Measurement Setup with the Non-AP MLD. The MS Query frame also carry an indication whether the Non-AP MLD intends to act as a Sensing Initiator MLD or it requests the AP MLD to act as the Sensing Initiator MLD.

FIG. 32B illustrates an embodiment of a Sensing Measurement Setup Request frame 3206, an embodiment of a Sensing Measurement Setup Response frame 3208, an embodiment of a Sensing Measurement Report frame 3210, an embodiment of a Sensing Session Setup Termination frame 3212, and an embodiment of a Sensing Measurement Setup Termination frame 3214 to be used in the embodiment 3100 of multi-link WLAN sensing procedure. In these embodiments of frames, a public action field is used in the frame body if the optional PASN process is not setup prior to the multi-link sensing measurement setup 3110. Alternatively, a protected action field is used in the frame body if the optional PASN process is setup prior to the multi-link sensing measurement setup 3110. Although not shown in the figure, the Sensing Measurement Setup Termination frame can also carry a “Terminate All Measurement Setup” bit and a “Terminate Session” bit as well. If the “Terminate All Measurement Setup” bit is set to 1, all Measurement Setup IDs between the two STAs/MLDs on all links are terminated and if the “Terminate Session” bit is set to 1, the Sensing session is terminated as well. Alternatively, if the “Terminate All Measurement Setup” bit is set to 1, it can also signal the termination of sensing session between the two STAs/MLDs on all links as well.

FIG. 33 illustrates a flowchart showing an embodiment 3300 of the optional Preassociation Security Negotiation (PASN) process 3109 as depicted in FIG. 31. The process establishes a Pairwise Transient Key Security Association (PTKSA) and corresponding shared keys between a PASN capable non-AP MLD 3102, 3304 and an AP MLD 3104, 3302.

In the embodiment, the AP MLD 3302 is an authenticator, while the non-AP MLD 3304 is a supplicant. The PASN process 3300 is initiated by the AP MLD 3302 transmitting a Beacon to the non-AP MLD 3304. The Beacon comprises RSNE (PASN AKM, BASE AKM) and RSNXE.

In response to receipt of the Beacon, the non-AP MLD 3304 conducts a first 802.11 Authentication process and transmits a first 802.11 Authentication result in a PASN first frame to the AP MLD 3302. The first 802.11 Authentication result includes an authentication ID 1, PASN, RSNE (BASE AKM, PMKID [0 . . . n]), [RSNXE], S-Ephemeral Pub, PASN Parameters, Base AKM Data-1, MAC Address, and MLO Linkₙ. In the PASN first frame, the MAC Address KDE carries the MLD MAC Address of the non-AP MLD 3304. MLO Linkₙ carries the MAC address, RSNE, and RSNEX, if advertised, for the STA affiliated with the MLD corresponding to the link with Link ID n. One MLO Linkₙ is carried for each of the links that is requested during the PA Sensing Session setup.

In response to receipt of the PASN first frame, the AP MLD 3302 conducts a second 802.11 Authentication process and transmits a second 802.11 Authentication result in a PASN second frame to the non-AP MLD 3304. The second 802.11 Authentication result includes an authentication ID 2, PASN, RSNE (BASE AKM, PMKID [0 . . . n]), [RSNXE], S-Ephemeral Pub, PASN Parameters, Base AKM Data-2, MAC Address, MLO Linkₙ, and MIC. In the PASN second frame, the MAC Address KDE carries the MLD MAC Address of the AP MLD 3302. MLO Linkₙ carries the MAC address, RSNE, and RSNEX, if advertised, for the STA affiliated with the MLD corresponding to the link with Link ID n. One MLO Linkₙ is carried for each of the links that is requested during the PA Sensing Session setup.

In response to receipt of the PASN second frame, the non-AP MLD 3304 verifies that the MLD MAC Address of the AP MLD 3302 and the MAC Addresses of each of the affiliated APs of the AP MLD 3302 match the expected values. Thereafter, the non-AP MLD 3304 transmits a third 802.11 Authentication result in a PASN third frame to the AP MLD 3302. The third 802.11 Authentication result includes an authentication ID 3, Base AKM Data-3, MAC Address, MLO Linkₙ, and MIC. In the PASN third frame, the MAC Address KDE carries the MLD MAC Address of the non-AP MLD 3304. MLO Link, carries the MAC address, RSNE, and RSNEX, if advertised, for the STA affiliated with the MLD corresponding to the link with Link ID n. One MLO Linkₙ is carried for each of the links that is requested during the PA Sensing Session setup.

As shown in FIG. 33, an unassociated non-AP MLD can initiate the PASN authentication with an AP MLD by exchanging the PASN frames (Authentication frames) on any one of the links. The PTKSA established using PASN is used to generate the Pairwise Temporal Key (PTK) that is used to protect the protected frames subsequently exchanged between the two MLDs. The PTKSA derivation for PASN is described as follows:

For PTKSA key derivation, the inputs to the PRF are the PMK of the PMKSA, a constant label and a concatenation of non-AP STA's MLD MAC address, AP's MLD MAC Address and the DH shared secret from the ephemeral exchange.

That is: KCK∥TK∥KDK=KDF-HASH-NNN (PMK, “PASN PTK Derivation”, SPMA∥AMA∥DHss), where:
PMK is the pairwise master key for the base AKM,
KCK is the key confirmation key of length 32 octets,
TK is the transient key,
KDK is Key Derivation Key used if higher layer security is supported,
KDF-HASH-NNN is the key derivation function defined in 802.11,
DHss is the shared secret derived from the PASN ephemeral key exchange encoded as an octet 35 string,
SPMA is the MLD MAC Address of the Supplicant (non-AP MLD), and
AMA is the MLD MAC Address of the Authenticator (AP MLD).

In addition, the MICs comprised in the PASN second and third frames can be derived as follows.

For MIC computation for PASN second frame, the MIC field of the MIC element in the PASN second frame is set by the AP MLD to the first MMM octets of:
HMAC-HASH (KCK, AMA∥SPMA∥Beacon RSNEs∥Beacon RSNXEs∥Frame Data).

For MIC computation for PASN third frame, the MIC field of the MIC element in the PASN third frame is set by the non-AP MLD to first MMM Octets of:
HMAC-HASH (KCK, SPMA∥AMA∥F1 Auth∥Frame Data).

In the above MIC computation for PASN second and third frames, SPMA is the MLD MAC Address of the Supplicant (non-AP MLD), AMA is the MLD MAC Address of the Authenticator (AP MLD), Beacon RSNEs and Beacon RSNEXs carry the RSNEs and RSNEXs of all the links that are setup for sensing.

FIG. 34 illustrates a flowchart showing an alternative embodiment 3400 of the method 400. In the alternative embodiment 3400, the method 400 is implemented as a multi-link WLAN ranging procedure 3400 among two first MLDs 3402, 3404 and a second MLD 3406.

In the present embodiment, similar to the embodiments of the multi-link WLAN sensing procedure, Location negotiation and Ranging ID assignment for multiple links can be performed over any one setup link. Ranging Measurement exchanges for multiple links can be triggered simultaneously (e.g., by upper layer) but the actual transmission of related PPDUs on each link may start at different times due to channel access delays. Location measurement report (LMR) of one link may be transmitted on another link. Multiple LMRs of different links may be aggregated and transmitted on one link.

In this embodiment, the first MLDs 3402, 3404 are non-AP MLDs that comprises three non-AP STAs 3408, 3410, 3412 and two non-AP STAs 3414, 3416 respectively. The second MLD 3406 is an AP MLD that comprises three Aps 3418, 3420, 3422. There are three links between the first MLD 3402 and the second MLD 3406, i.e., Link 1 between AP 3420 and non-AP STA 3410 in the 5 GHz band, Link 2 between AP 3408 and non-AP STA 3418 in the 2.4 GHz band, and Link 3 between AP 3412 and non-AP STA 3422 in the 6 GHz band. There are two links between the additional first MLD 3404 and the second MLD 3406, i.e., Link 1 between AP 3420 and non-AP STA 3414 in the 5 GHz band, and Link 3 between AP 3422 and non-AP STA 3416 in the 6 GHz band.

In this embodiment, the multi-link WLAN ranging procedure 3400 includes a Location negotiation and Ranging ID assignment session 3424 between the first non-AP MLD 3402 and the AP MLD 3406, in which the first non-AP MLD 3402 is configured as a ranging initiator MLD and the AP MLD 3406 is configured as a ranging responder MLD and Links 1 and 3 between the first non-AP MLD 3402 and the AP MLD 3406 are associated with the Location negotiation and Ranging ID assignment session 3424.

The multi-link WLAN ranging procedure 3400 further includes another Location negotiation and Ranging ID assignment session 3426 between the second non-AP MLD 3404 and the AP MLD 3406, in which the first MLD 3404 is configured as a ranging initiator MLD and the AP MLD 3406 is configured as a ranging responder MLD and Links 1 and 3 between the second non-AP MLD 3404 and the AP MLD 3406 are associated with the Location negotiation and Ranging ID assignment session 3424.

The multi-link WLAN ranging procedure 3400 further includes a Trigger Based (TB) Ranging 3428 between the first non-AP MLD 3402 and the second non-AP MLD 3404 with the AP MLD 3406. In the TB Ranging 3428, the ranging measurements on the respective Links 1 and 3 are exchanged between the first non-AP MLD 3402 with the AP MLD 3406 and between the second non-AP MLD 3404 with the AP MLD 3406 after a polling phase and a measurement sounding phase, similar to those described above in the TB multi-link sensing measurement procedures, e.g., with regard to FIG. 18.

The multi-link WLAN ranging procedure 3400 further includes a Location Measurement Report 3430 with the first non-AP MLD 3402 on Link 1. The Report 3430 includes an aggregated R2I Location Measurement Report (LMR) for Links 1, 3, a Tigger Frame (TF) Ranging LMR, and a I2R LMR for Links 1, 3. It can be seen that LMRs of links 1, 3 are transmitted on Link 3.

Similarly, the multi-link WLAN ranging procedure 3400 further includes a Location Measurement Report 3432 with the second non-AP MLD 3404 on Link 1. The Report 3432 includes an aggreated R2I Location Measurement Report (LMR) for Links 1, 3, a Tigger Frame (TF) Ranging LMR, and a I2R LMR for Links 1, 3.

In this embodiment, the MLD adaptation of PASN as described above in multi-link WLAN sensing procedures is also applicable to the multi-link WLAN ranging procedure 3400.

The present disclosure can be realized by software, hardware, or software in cooperation with hardware. Each functional block used in the description of each embodiment described above can be partly or entirely realized by a LSI, such as an integrated circuit, and each process described in each embodiment may be controlled partly or entirely by the same LSI or a combination of LSIs. The LSI may be individually formed as integrated circuit chips, or one chip may be formed so as to include a part or all of the functional blocks. The LSI may include a data input and output coupled thereto. The LSI may be referred to as an integrated circuit (IC), a system LSI, a super LSI, or an ultra-LSI depending on a difference in the degree of integration. However, the technique of implementing an integrated circuit is not limited to the LSI and may be realized by using a dedicated circuit, a general-purpose processor, or a special purpose processor. In addition, a Field Programmable Gate Array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

The communication apparatus may comprise a transceiver and processing/control circuitry. The transceiver may comprise and/or function as a receiver and a transmitter. The transceiver, as the transmitter and receiver, may include a radio frequency (RF) module including amplifiers, RF modulators/demodulators and the like, and one or more antennas.

Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (e.g., digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”. The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus may also include an infrastructure facility, such as a base station, an access point, and any other apparatus, device or system that communicates with or controls apparatuses such as those in the above non-limiting examples.

The present disclosure may be applied to any of uplink, downlink and sidelink communications.

The present disclosure may be applied to any of a licensed band and an unlicensed band.

The present disclosure may be applied to any of communication between a base station and a terminal (Uu-link communication), communication between a terminal and a terminal (Sidelink communication), and Vehicle to Everything (V2X) communication.

An antenna port refers to a logical antenna (antenna group) formed of one or more physical antenna(s). That is, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal is allowed to transmit a reference signal. The antenna port may also be defined as the minimum unit for multiplication of a precoding vector weighting.

While exemplary embodiments have been presented in the foregoing detailed description of the present disclosures, it should be appreciated that a vast number of variations exist. It should further be appreciated that the exemplary embodiments are only examples, and are not intended to limit the scope, applicability, operation, or configuration of the present disclosure in any way. Rather, the foregoing detailed description will provide those skilled in the art with a convenient road map for implementing exemplary embodiments, it being understood that various changes may be made in the function and arrangement of the communication apparatuses, either as a first MLD or as a second MLD, as described in the exemplary embodiments without departing from the scope of the present disclosure as set forth in the appended claims.

1. A first multi-link device (MLD) comprising a first plurality of affiliated stations (STAs),
wherein the first MLD comprises: at least one transceiver, and circuitry, wherein the at least one transceiver works in conjunction with the circuitry, which in operation enables one or more STAs of the first plurality of affiliated STAs to perform measurement operations with one or more STAs of a second plurality of affiliated STAs comprised in a second MLD.

2. The first MLD of claim 1, wherein the measurement operations comprise one or more of a sensing measurement, a ranging measurement, and/or a fine time measurement (FTM).

3. The first MLD of claim 2, wherein a STA of the first plurality of affiliated STAs transmits a request frame to a STA of the second plurality of affiliated STAs to request a measurement setup procedure or a measurement termination procedure,
wherein the measurement setup procedure is configured to allow the measurement operations to be performed on one or more links established between the first MLD and the second MLD, and
wherein the measurement termination procedure is configured to terminate the measurement setup procedure established between the first MLD and the second MLD.

4. The first MLD of claim 3, wherein the measurement setup procedure comprises one of a sensing session setup or a sensing measurement setup, and wherein the measurement termination procedure comprises one of a sensing session termination or a sensing measurement termination,
wherein the sensing session setup is configured to identify the one or more links established between the first MLD and the second MLD, and wherein one or more sensing operations are performed on one or more of the identified links, and
wherein the sensing measurement setup is used to negotiate sensing operation attributes for each of the one or more of the identified links.

5. The first MLD of claim 4, wherein the sensing operation attributes comprise sensing transmitter or receiver roles, measurement report type, and sampling rate on each of the one or more of the identified links.

6. The first MLD of claim 3, wherein the measurement setup procedure comprises a location negotiation and ranging identifier (ID) assignment procedure.

7. The first MLD of claim 1, wherein the first MLD comprises a single interface to upper layer applications, wherein the upper layer applications configure the one or more STAs of the first plurality of affiliated STAs to perform the measurement operations with the one or more STAs of the second plurality of affiliated STAs comprised in a second MLD over one or more links.

8. The first MLD of claim 4, wherein a sensing measurement setup is identified with a same measurement setup identifier (ID) on one or more of the identified links, and wherein for each of the one or more of the identified links:
a link ID of each of the one or more of the identified links together with the measurement setup ID is used to identify the sensing operation attributes specific to the each of the one or more of the identified links.

9. The first MLD of claim 4, wherein a sensing measurement instance of a sensing measurement setup is identified with a same measurement instance identifier (ID) on one or more of the identified links and wherein for each of the one or more of the identified links:
a link ID of each of the one or more of the identified links together with the measurement instance ID is used to identify a sensing measurement instance specific to each of the one or more of the identified links

10. The first MLD of claim 4, wherein the first MLD is configured to initiate a sensing measurement instance with the second MLD by transmitting a measurement PHY protocol data unit (PPDU) on a first link of the identified links and requesting a STA affiliated with the second MLD operating on the first link to perform sensing measurements on the measurement PPDU and another STA affiliated with the second MLD operating on a second link of the identified links to transmit a sensing measurement report on the second link,
wherein the sensing measurement report carries a result of the sensing measurement performed on the first link,
and wherein a STA affiliated with the first MLD operating on the second link is configured to receive the sensing measurement report.

11. The first MLD of claim 4, wherein the first MLD is configured to initiate a sensing measurement instance with the second MLD by transmitting a plurality of measurement PPDUs on a first set of links of the identified links and requesting STAs affiliated with the second MLD operating on the first set of links to perform sensing measurements on the plurality of measurement PPDUs and to transmit a set of sensing measurement reports on a second link of the identified links,
wherein the set of sensing measurement reports carry a set of results of the sensing measurements performed on the first set of links of the identified links,
wherein a STA affiliated with the first MLD operating on the second link is configured to receive the set of sensing measurement reports, and
wherein the second link is one of the first set of links or other than those in the first set of links.

12. The first MLD of claim 10, wherein the second link is indicated in a null data packet announcement (NDPA) frame or a Trigger frame of the measurement PPDU or the plurality of measurement PPDUs.

13. The first MLD of claim 1, wherein the first MLD is an access point (AP) MLD and each of the first plurality of affiliated STAs is an AP, and wherein the second MLD is a non-AP MLD and each of the second plurality of affiliated STAs is a non-AP STA.

14. A second multi-link device (MLD) comprising a second plurality of affiliated stations (STAs), wherein the second MLD comprises at least one transceiver, and circuitry, wherein the at least one transceiver works in conjunction with the circuitry, which in operation enables at least one STA of the second plurality of affiliated STAs to receive a request frame from at least one STA of a first plurality of affiliated STAs comprised in a first MLD,
wherein the request frame is configured to request a measurement setup procedure or a measurement termination procedure,
wherein the measurement setup procedure is configured to allow measurement operations to be performed on one or more links established between the first MLD and the second MLD, and
wherein the measurement termination procedure is configured to terminate the measurement setup procedure established between the first MLD and the second MLD.

15. The second MLD of claim 14, wherein the measurement operations comprise one or more of a sensing measurement, a ranging measurement, and/or a fine time measurement (FTM), wherein the measurement setup procedure comprises one of a sensing session setup or a sensing measurement setup, and wherein the measurement termination procedure comprises one of a sensing session termination or a sensing measurement termination.

16. The second MLD of claim 15, wherein the second MLD is configured to participate in a sensing measurement instance initiated by the first MLD on a first link of the one or more links between the first MLD and the second MLD,
wherein a STA affiliated with the second MLD operating on the first link is configured to receive a measurement PPDU from the first MLD on the first link and performs sensing measurement,
wherein a STA affiliated with the second MLD operating on a second link of the one or more links is configured to transmit a sensing measurement report on the second link, and
wherein the sensing measurement report carries a result of the sensing measurement performed on the first link.

17. The second MLD of claim 15, wherein the second MLD is configured to participate in a sensing measurement instance initiated by the first MLD on a first set of links of the one or more links between the first MLD and the second MLD,
wherein STAs affiliated with the second MLD operating on the first set of links are configured to receive a plurality of measurement PPDUs from the first MLD on the first set of links and performs sensing measurement,
wherein a STA affiliated with the second MLD operating on a second link of the one or more links is configured to transmit a single sensing measurement report frame on the second link,
wherein the single sensing measurement report frame carries results of the sensing measurement performed on the first set of links, and
wherein the second link is one of the first set of links or other than those in the first set of links.

18. The second MLD of claim 14, wherein the second MLD is a non-access point (non-AP) MLD and each of the second plurality of affiliated STAs is a non-AP STA, and wherein the first MLD is an access point (AP) MLD and each of the first plurality of affiliated STAs is an AP.

19. A method for multi-link operations at the first multi-link device (MLD) of claim 1.

20. A method for multi-link operations at the second multi-link device (MLD) of claim 14.
